(19) United States
(12) Patent Application Publication
(10) Pub. No.: US 2025/0340379 A1
(43) Pub. Date: Nov. 6, 2025

(54) A COMBINED POWER AND DATA UNIT FOR A STORAGE AND RETRIEVAL SYSTEM, AND RELATED DEVICES

(71) Applicant: OCADO INNOVATION LIMITED, Hatfield, Hertfordshire (GB)

(72) Inventors: Robert STADIE, Hatfield, Hertfordshire (GB); Matthew WHELAN, Hatfield, Hertfordshire (GB); John LONG, Hatfield, Hertfordshire (GB)

(73) Assignee: OCADO INNOVATION LIMITED, Hatfield, Hertfordshire (GB)

(21) Appl. No.: 18/868,851

(22) PCT Filed: May 26, 2023
(86) PCT No.: PCT/EP2023/064266

§ 371 Date: Nov. 25, 2024

(30) Foreign Application Priority Data
May 26, 2022 (GB) 2207782.0

(51) Int. Cl. B65G 1/137

(52) U.S. Cl. CPC B65G 1/1371

(57) ABSTRACT

A method is disclosed of providing software updates to a load handling device for use in a storage and retrieval system which includes a first set of parallel tracks extending in an X-direction, and a second set of parallel tracks extending in a Y-direction transverse to the first set in a substantially horizontal plane to form a grid pattern including a plurality of grid spaces. The method includes transferring computer readable code to a combined power and data unit, the combined power and data unit including a rechargeable power source and a data storage module such that the computer readable code is stored in the data storage module; and connecting the combined power and data unit to an interface of a load handling device such that the local processing unit of the load handling device can access the computer readable code stored in the data storage module.

The invention relates to automated storage and retrieval systems, devices and methods for operating automated storage and retrieval systems. More specifically but not exclusively, it relates to high density or cubic storage systems using combined power and data units. Combined power and data units relate to power load handling devices operating on the automated storage and retrieval system. Also, to provide means for local data transfer from load handling devices, and storage and transfer of computer readable code.

### BACKGROUND

EP 1037828 B1 (Autostore) describes a system in which stacks of containers are arranged within a frame structure. A system of this type is illustrated schematically in FIGS. 1 to 4 of the accompanying drawings. Robotic load handling devices can be controllably moved around the stack on a system of tracks on the uppermost surface of the stack.

A load handling device is described in UK Patent Application No. GB2520104A—Ocado Innovation Limited—where each robotic load handler only covers one grid space, thus allowing high density of load handlers and thus high throughput of a given size system.

In the known robotic picking systems described above, robotic load handling devices are controllably moved around the top of the stacks on a track system forming a grid. A given load handling device lifts a bin from the stack, the container being lifted containing inventory items needed to fulfil a customer order. The container is carried to a pick station where the required inventory item may be manually removed from the bin and placed in a delivery container, the delivery container forming part of the customer order, and being manually filled for dispatch at the appropriate time. At the pick station, the items may also be picked by industrial robots, suitable for such work, for example as described in UK Patent Application No GB2524383B-Ocado Innovation Limited.

As shown in FIGS. 1 and 2, stackable storage containers, known as bins 9, are stacked on top of one another to form stacks 11. The stacks 11 are arranged in a framework 3, 5, 7 in a warehousing or manufacturing environment. FIG. 1 is a schematic perspective view of the framework 3, 5, 7, and FIG. 2 is a top-down view showing a single stack 11 of bins 9 arranged within the framework 3, 5, 7. Each bin 9 typically holds a plurality of product or inventory items, and the inventory items within a bin 9 may be identical, or may be of different product types depending on the application. Furthermore, the bins 9 may be physically subdivided to accommodate a plurality of different inventory items.

The top level of the framework 3, 5, 7 a track structure 13 or rails arranged in a grid pattern across the top of the stacks 11. The track structure 13 supports a plurality of robotic load handling devices 31. A first set of parallel rails 17 guide movement of the load handling devices 31 in a first direction (X) across the top of the framework 3, 5, 7, and a second set of parallel rails 19, arranged perpendicular to the first set 17, guide movement of the load handling devices 31 in a second direction (Y), perpendicular to the first direction. In this way, the rails 17, 19 allow movement of the load handling devices 31 in two dimensions in the X-Y plane, so that a load handling device 31 can be moved into position above any of the stacks 11.

FIG. 3 shows a plurality of load-handling devices 31 moving on top of the storage structure 1. As illustrated in detail in FIG. 4, each load handling device 31 comprises a body 33 which is arranged to travel in the X and Y directions on the track structure 13 above the stacks 11. A first set of wheels 35 are arranged to engage with two adjacent rails of the first set of rails 17. Similarly, a second set of wheels 37 are arranged to engage with two adjacent rails of the second set of rails 19. Each set of wheels 35, 37 can be lifted and lowered, so that either the first set of wheels 35 or the second set of wheels 37 is engaged with the respective set of rails 17, 19 at any one time. In this way, one or more robotic load handling devices 31 can move around the track structure 13 under the control of a centralised control utility (not shown).

Each robotic load handling device 31 is provided with lifting means 39 for lifting one or more bins 9 from the stack 11 to access the required products. In this way, multiple products can be accessed from multiple locations in the grid and stacks at any one time.

FIGS. 1 and 3 show the bins 9 in stacks 11 within the storage system. It will be appreciated that there may be a large number of bins 9 in any given storage system and that many different items may be stored in the bins 9 in the stacks 11. Each bin 9 may contain different categories of inventory items within a single stack 11.

In one system described above and further in UK Patent Application Number GB2517264A—Ocado Innovation Limited, hereby incorporated by reference—the storage system comprises a series of bins that may further comprise delivery containers DT with customer orders contained therein or may further comprise bins with inventory items awaiting picking contained therein. These different bins and combinations thereof may be contained in the storage system and be accessed by the robotic load handling devices 31 as described above.

In this specification, the terms “bin”, “container”, and “storage container” are used interchangeably to refer to the same entity.

As described in WO2019215221 (Ocado) typically load handling devices are battery powered during operation and the battery is recharged while the robotic load handling device is operative on the grid framework structure at a charge station. The charge station is fixed to a structure proximate to the grid framework structure and extends over a nominal grid cell at an edge of the grid structure. A robotic load handling device may be charged by being instructed to move to a charge station grid cell. Contact is made between a charge contact pad on a top surface of the robotic load handling device and the charge station. A charge is imparted to the robotic load handling device through the contact pad. Additionally, the contact may be used for data transfer during charging. WO′221 provides a charge unit for a robotic load handling device operative on top of a grid framework. The charge unit comprises a plurality of profiled sections arranged to interface with a hoist element of the robotic load handling device, and a power transfer means arranged to transfer power to the robotic load handling device.

In systems where the load handling device is recharged, typically each load handling device may spend 5% to 6% of its time at a charge-station. Reducing the amount of time each load handling device spends at a charge-station may provide efficiency gains to the system: allowing more time for the load handling device to perform load handing operations; and by reducing the number of charge-stations required.

In systems having hundreds and in some cases thousands of bots or load handling devices per grid, and with each load handling device collecting large data logs, it will be appreciated that typical data transfer systems such as RF communication systems may not provide sufficient bandwidth for all the bots to transmit detailed logging information all the time over the wireless communication system in real-time. Further, reducing the amount of time spent at a charge-station may leave insufficient time for complete data transfer.

EP3325228B1 (Boston Dynamics Inc.) discloses a battery and hard drive exchange station for robots. A battery pack may include a rechargeable battery and a local data storage component. During operation, sensor data is acquired by the mobile robotic device and is transferred to the local data storage component. At a battery exchange station, the battery pack containing the battery and the local data storage data component with the sensor are transferred to the battery exchange station. A second battery pack from the battery exchanged station is received by the mobile robotic device, to continue operation.

It is against this background that the present invention has been devised.

It will be appreciated that while the system, devices, methods, and computer programs described herein are described using grocery systems as an example, automated or semi-automated storage and retrieval systems are not limited to systems directed to groceries. For example, the technology can be applied to shipping, baggage handling, vehicle parking, indoor or hydroponic greenhouses and farming, modular buildings, self-storage facilities, cargo handling, transport switchyards, manufacturing facilities, pallet handling, parcel sortation, airport logistics (ULD) and general logistics to name but a few possible applications. It will be appreciated that storage and retrieval systems of different types will have different technical requirements.

The claimed system, devices, methods, and computer programs are intended to provide improvements relating to rechargeable power sources for bots operating on storage and retrieval systems, and data transfer.

### SUMMARY

Aspects of the invention are set out in the accompanying claims.

### Method

A method of providing software updates to a load handling device for use in a storage and retrieval system, the storage and retrieval system comprising:
a first set of parallel tracks extending in an X-direction, and a second set of parallel tracks extending in a Y-direction transverse to the first set in a substantially horizontal plane to form a grid pattern comprising a plurality of grid spaces;
   the method comprising the steps of:
transferring computer readable code to a combined power and data unit, the combined power and data unit comprising a rechargeable power source and a data storage module such that the computer readable code is stored in the data storage module;
connecting the combined power and data unit into an interface of a load handling device such that the local processing unit of the load handling device can access the computer readable code stored in the data storage module.

Connecting the combined power and data unit into an interface of a load handling device may comprise inserting the combined power and data unit into the load handling device. The interface of the load handling device may provide electrical coupling between the rechargeable power source and the load handling device, such that the rechargeable power source can provide power to enable the load handling device to move on the track system.

The rechargeable power source and the data storage module are combined as a single unit i.e. as a combined power and data unit. At an exchange station, the combined power and data unit may be removed from the load handling device and replaced with a replacement/second combined power and data unit. The combined power and data unit may comprise a mechanical release mechanism to allow the combined power and data unit to be removed from the load handling device and or from an exchange station.

It will be understood that the power source is rechargeable, so the terms “power source” and “rechargeable power source” are used interchangeably in this specification.

The rechargeable power source may comprise a battery or a super-capacitor. Examples of rechargeable batteries are Lithium-Ion battery, Nickel-Cadmium battery, Nickel-Metal Hydride battery, Lithium-Ion Polymer battery, Lithium Titanium Oxide, Thin Film battery and Smart battery Carbon Foam-based Lead Acid battery.

Typically, the data storage module may be partitioned into a local data storage component, a component for computer readable code, and or other components for other data uses.

It will be appreciated that loading computer readable code to the combined power and data unit reduces the requirement to transmit computer readable code over wireless communication channels, making further wireless bandwidth available. Further it will be appreciated that using the combined power and data units to transfer data to and from the load handling device may significantly reduce the total load on wireless communication channels within the system.

The computer readable code may comprise operational files, computer executable instructions, software, firmware, data, one or more data parameters, and/or updates to the computer readable code, as will be described in more detail later.

The computer readable code may comprise computer executable instructions such that a local processing unit of the load handling device executes the computer executable instructions to control the operation of the load handling device.

The computer readable code may comprise one or more data parameters which are accessed by the local processing unit of the load handling device during the operation of the load handling device.

The one or more data parameters may comprise one or more operational limits for components of the load handling device (for example speed, acceleration, deceleration, torque, power, voltage, current). The one or more data parameters may comprise a grid-map data file. The grid-map data file may be used by the load handling devices to integrity check movement commands received by the load handling device from a system controller. For example, to avoid obstacles or excluded areas on the grid. Obstacles can be either permanent (e.g. pillars in the building where the storage system is located) or temporary (e.g. sections of the track structure closed for maintenance). The grid-map data file may also contain information about the edges or boundaries of the grid. It will be appreciated that the grid-map data file may change for a number of reasons, for example, due to routine maintenance on the grid, or due to stranded load handling devices awaiting recovery from the grid. In addition to, or alternatively, the grid-map data file may provide data for navigational computations.

The one or more data parameters may comprise speed or acceleration limits for the load handling device, for example a maximum linear speed at which the load handling device can move on the track system (e.g. 4 m/s), or a maximum acceleration for the load handling device on the track system (e.g. 2 m/s²). The one or more data parameters may comprise speed or torque limits for one or more electric motors powering the load handling device. The one or more data parameters may comprise other parameter limits for other components of the load handling device.

In some examples the computer readable code may comprise both computer executable instructions and one or more data parameters. For example, the computer readable code may comprise computer executable instructions for controlling a motor driving the wheels of the load handling device, in conjunction with data parameters comprising a speed and/or torque limit for the motor driving the wheels of the load handling device.

The method may comprise the further step of the load handling device transferring some or all of the computer readable code from the data storage module of the combined power and data unit to a data storage medium of the load handling device.

The load handling device may further comprise a data storage medium housed within the load handling device, wherein the local processing unit is configured to establish a data channel between the data storage medium and the data storage module such that computer readable code stored on the data storage module is transferred to the data storage medium when the combined power and data unit is connected to the interface of the load handling device. The local processing unit may be arranged to read, and update computer readable code of the load handling device from the computer readable code stored on the data storage module. In this way, the local processing unit may update the load handling device from the combined power and data storage unit rather than over the system's communication network. The computer readable code stored in the data storage module may comprise one or more new versions of portions of the computer readable code that are to be deployed to the load handling device. In this way, load handling devices may be updated with new versions of the computer readable code used by the load handling device's local processing unit. New versions or updated versions of the computer readable code which are loaded onto the data storage module of a combined power and data unit will be deployed to the load handling device to which the combined power and data unit is connected. The new or updated versions of the computer readable code may be deployed immediately upon connecting a combined power and data unit to the interface of a load handling device, or alternatively the local processing unit of the load handling device may be instructed to wait until receiving a signal from the system controller before deploying a new or updated version of portion of computer readable code, as will be described later.

For all files downloaded from the combined power and data unit to a load handling device a Checksum, Cyclic Redundancy Code (CRC) or similar verification of download integrity may be performed.

Transfer of power and or data within the load handling device may be by wireless transmission. The load handling device may overwrite computer readable code stored on the data storage medium of the load handling device with computer readable code transferred from the data storage module of the combined power and data unit. In some examples, the entirety of the computer readable code stored on the data storage medium of the load handling device may be overwritten with computer readable code transferred from the data storage module of the combined power and data unit. In other examples, one or more portions of the computer readable code stored on the data storage medium of the load handling device may be overwritten with computer readable code transferred from the data storage module of the combined power and data unit.

The storage system may further comprise one or more exchange stations, the or each exchange station being configured to connect a combined power and data unit to the interface of a load handling device or to remove a combined power and data unit from the interface of a load handling device, the method comprising the further step of transmitting computer readable code to an exchange station such that the computer readable code can be transferred to the data storage module of a combined power and data unit connected to said exchange station.

In some examples the computer readable code may be transmitted to the exchange station from a system controller. In other examples the computer readable code may be transmitted to the exchange station manually, e.g. by a human worker.

An advantage of the step of connecting a combined power and data unit to the interface of a load handling device is that the amount of time that the load handling devices spend waiting at a charge station or exchange station may be significantly reduced. The load handling device does not need to wait at a station while the rechargeable power source is recharged. Nor does the load handling device need to wait at an exchange station while data is transferred to and from the load handling device. Instead, the load handling device may simply move to an exchange station when the combined power and data unit is low on power, depleted or the local data storage component is approaching full capacity, have the combined power and data unit swapped out and replaced with a ‘refreshed’ combined power and data unit, and return to operations on the track structure.

The storage system may further comprise a system controller configured to transmit computer readable code to the or each exchange station, the method comprising the further step of the system controller preventing the local processing unit of the load handling device from accessing the computer readable code until a predetermined condition is met. For example, the system controller may allow the local processing unit to access the computer readable code once a predetermined condition is met, for example at a predetermined time, or when all load handling devices in a system are provided with the computer readable code, or in response to a specific event.

The computer readable code may comprise one or more data parameters which comprise predetermined timestamps at which associated portions of the computer readable code may be accessed by the local processing unit of the load handling device. When the current time reaches the predetermined timestamp, the associated portions of the computer readable code may be accessed by all load handling devices in the storage and retrieval system at the same time, allowing changes to be deployed simultaneously across a fleet of load handling devices. The load handling device may comprise a communications module configured to receive communications from the system controller such that one or more portions of the computer readable code are accessed by the local processing unit of the load handling device in response to the receipt of a control message from the system controller.

The method may comprise the further step of the load handling device overwriting computer readable code stored on the data storage medium of the load handling device in response to the receipt of a control message from the system controller.

### Load Handling Device

A load handling device is provided for use in a storage and retrieval system, the storage and retrieval system comprising:
a first set of parallel tracks extending in an X-direction, and a second set of parallel tracks extending in a Y-direction transverse to the first set in a substantially horizontal plane to form a grid pattern comprising a plurality of grid spaces;
a plurality of stacks of storage containers located beneath the tracks, and arranged such that each stack is located within a footprint of a single grid space; the load handling device comprising:
a driving assembly configured to move the load handling device on one of the sets of parallel tracks;
a lifting mechanism configured to lift a storage container from a stack;
a communication module for receiving data from and/or transmitting data to a system controller;
a local processing unit in communication with the communication module;
an interface configured to:
i) connect to a combined power and data unit, the combined power and data unit comprising a rechargeable power source and a data storage module;
ii) electrically couple to the rechargeable power source such that, in use, the driving assembly is powered by the rechargeable power source; and
iii) communicate with the data storage module; wherein:
the data storage module comprises computer readable code;
the local processing unit is configured, in use, to access the computer readable code.

The interface connecting to a combined power and data unit may comprise inserting the combined power and data unit into the load handling device.

The driving assembly may allow the load handling device to move in x- and y-directions to any available grid cell location on the tracks. The first set of parallel tracks extending in an X-direction and the second set of parallel tracks extending in a Y-direction may together be referred to as the track system, or the grid. At the grid cell location the load handling device may retrieve containers from a stack, or deposit containers into a stack. In this way, items are stored and retrieved in the storage and retrieval system. The communication module may be in communication with a system controller which directs the movements and lifts performed by the load handling device.

The interface may be a receptacle or a slot configured to receive a combined power and data unit. A load handling device may comprise a plurality of slots for receiving combined power and data units that are electrically and mechanically compatible with the combined power and data units. In this way, the load handling device may have a longer run time before needing to visit an exchange station. Alternatively, the load handling device may remain powered by a first combined power and data unit while a second combined power and data unit is replaced, for example.

The receptacle may be located in the upper part of the housing or skeleton of a load handling device. In this way, the receptacle may be readily accessible from the exterior of the load handling device by a human operative or by a robotic arm designed to replace combined power and data units. By locating the combined power and data unit in the upper part of the load handling device, the lower part of the load handling device may be reserved for receiving and holding containers that have been lifted from stacks. It will be appreciated that the receptacle may be located in or on any accessible part of the load handling device.

The receptacle may comprise a mechanical release mechanism, compatible with a mechanical release mechanism of a combined power and data unit to allow the combined power and data unit to be removed from the load handling device. The mechanical release mechanism may hold a combined power and data unit in the receptacle when the load handling device is not at an exchange station and prevent the combined power and data unit from falling out of the receptacle when the load handling device is moving on the grid.

The load handling device may further comprise means for detecting a continuous power source in the receptacle.

A continuous power source might be detected as a voltage in a specified range for a specified time, without interruption, for example. Once this is detected the load handling device may power up or re-activate.

The receptacle may comprise a light unit for locating a combined power and data unit.

The receptacle may comprise one or more light units for displaying signals that are visible to a human operator or an exchange station. The light units may guide removal/insertion of combined power and data units. The one or more light units may display pre-arranged coded signals, for example, using colour and or amplitude modulation. A specific light signal may identify a specific receptacle. In this way, a human operator or robotic arm at an exchange station may be guided to the correct vacant slot in the exchange station.

The load handling device may be semi-autonomous, taking instructions from the system controller via the communication means. The local processing unit may operate the driving assembly and the lifting mechanism. The local processing unit may also be described as a local control unit.

Computer executable instructions may include firmware or software. Firmware is software for the specific purpose of controlling hardware. For example, computer executable instructions may include load handling device control software for controlling one or more parts of the load handling device, for example the lifting mechanism or the driving assembly. Components and subsystems of the load handling device may be powered by one or more electric motors (for example the lifting mechanism and/or the driving assembly and/or other components), and computer executable instructions may include load handling device motor drive controlling software for controlling the one or more electric motors. Computer executable instructions may include load handling device communication software for controlling the transmitting of data from the communication module of the load handling device to a system controller, and/or the receiving of data from a system controller to the communication module of the load handling device.

Computer executable instructions may include instructions for controlling the drive assembly of the load handling device, controlling the wheels of the load handling device in order to enable the load handling device to move on the track structure, and/or controlling the direction of travel of the load handling device by controlling which set of wheels are engaged with the tracks of the track system. Computer executable instructions can also be used to control other components of the load handling device, for example controlling the lifting mechanism to lift a container from a stack or to lower a container onto a stack.

The local processing unit may be configured, in use, to selectively execute computer executable instructions stored on either the data storage module of the combined power and data unit or the data storage medium of the load handling device.

The computer readable code may comprise computer executable instructions for controlling the lifting mechanism.

The computer readable code may comprise computer executable instructions for controlling the communication module receiving data from and/or transmitting data to a system controller.

The load handling device may further comprise a wheel assembly driven by the driving assembly, said wheel assembly comprising a first set of wheels for engaging with the first set of tracks to guide movement of the load handling device in the first direction and a second set of wheels for engaging with the second set of tracks to guide the movement of the load handling device in the second direction, wherein the computer readable code may comprise computer executable instructions for controlling the driving mechanism of the wheel assembly.

The load handling device may further comprise a directional change mechanism configured to selectively engage the first set of wheels with the first set of tracks and the second set of wheels with the second set of tracks, wherein with the computer readable code comprises computer executable instructions for controlling the operation of the directional change mechanism.

The computer readable code may comprise one or more data parameters and the local processing unit may be configured, in use, to access one or more of the data parameters during the operation of the load handling device.

The one or more data parameters may comprise a grid-map data file for determining one or more pathways across the track structure for the load handling device.

The local processing unit may be configured, in use, to overwrite computer readable code stored on the data storage medium of the load handling device with computer readable code transferred from the data storage module of the combined power and data unit.

The load handling device may further comprise one or more position sensors configured for sensing one or more position markers on the track system, wherein the computer readable code may comprise data acquired from the one or more position sensors such that the position of the load handling relative to the track system can be controlled based on the acquired position sensor data.

The computer executable instructions may comprise a position controller associated with controlling the position of the load handling relative to the track system based on the one or more position sensors.

The one or more position markers may comprise RFID tags. In use, the position sensor detects the position markers on the tracks. The position controller uses information from the sensors to determine whether the actual position of the load handling device is displaced from the expected/nominal position on the tracks (for example, the load handling device's nominal/expected position may be directly above a grid cell ready to lift a storage container). The position controller can then calculate any necessary position adjustment to move the load handling device to the nominal/expected position and instruct the load handling device to adjust its position accordingly.

The load handling device may further comprise one or more sensors for recording diagnostic data, wherein the computer readable code comprises the stored diagnostic data. Alternatively, the local processing unit may be configured to store the diagnostic data in the data storage module.

The load handling device may further comprise means for writing one or more diagnostic logs to the data storage module. As noted above, the load handling device may collect data logs, for example diagnostic data or diagnostic logs. The diagnostic logs may be written to a local storage component of the data storage module. Detailed logs may be required to diagnose faults, to analyse and improve performance, and to analyse and improve reliability of the load handling device and other load handling devices operating in the system.

Further, it will be appreciated that having access to detailed logs, for substantially each of the load handling devices, for substantially all of the time, performance of individual load handling devices can be compared to other load handling devices.

Typically during operation moving on the grid, the load handling devices may collect data logs, for example diagnostic logs. Data can be generated from sensors on the load handling device, for example temperature sensors, position sensors, and accelerometers. Also, data can be collected from the power source, for example data from a battery management system. Error logs from the load handling device may also be collected and stored. Such detailed diagnostic logs may not be available in real-time using typical data transfer systems (for example RF communication systems) because the large quantity of data may require more bandwidth than the data transfer system can provide. Instead, these diagnostic logs may be stored in the data storage module of the combined power and data unit. Accordingly, when a combined power and data unit is removed from a load handling device, the diagnostic logs are removed also. The load handling device may further comprise a charge receiving connector configured to connect to a corresponding connector on a combined power and storage unit when connected to the interface, the charge receiving connector being configured to:
electrically couple to and receive power from the power source; and
interface with the data storage module.

Advantageously, the charge receiving connector fulfils two functions simultaneously, i.e. the same connector can both receive charge and transfer data. Data can be transferred in both directions; for example computer readable code can be transferred from the data storage module in the combined power and data unit to the data storage medium in the load handling device, and diagnostic data can be transferred from the data storage medium in the load handling device to the data storage module in the combined power and data unit.

A high speed data link may be required, for example USB 2.0 which can provide a transfer speed of 480 Mbit/second. The data storage module may comprise one or more USB flash memory sticks, which are widely and cheaply available, and designed for hot-swap connection. The charge receiving connector may comprise a power connector, ground connector, and a differential pair of data connectors, and the corresponding connector on the combined power and data unit may comprise a corresponding power connector, ground connector, and corresponding differential pair of data connectors. The charge receiving connector and/or the corresponding connector on the combined power and data unit may comprise a shield to protect the connectors from electromagnetic interference.

### Exchange Station

In another aspect, an exchange station is provided for connecting/disconnecting a combined power and data unit to/from a load handling device as defined herein, the exchange station comprising:
an actuator configured to releasably hold and move the combined power and data unit; and
an interface arranged to connect to a combined power and data unit, the interface being arranged to establish a data channel with the combined power and data unit to receive data from and/or transfer data to the data storage module of the combined power and data unit connected to the interface;
   wherein the exchange station is configured to update computer readable code in the data storage module when the combined power and data unit is connected to the interface.

Connecting/disconnecting the combined power and data unit to/from a load handling device may comprise inserting/removing the combined power and data unit into/from the load handling device. The interface may take the form of a plug and socket, i.e. the interface may be a recess or receptacle or socket, within which a combined power and data unit may be inserted. Alternatively the interface may take any other suitable form, and is not limited to the combined power and data unit being inserted into or received within the interface. For example, the combined power and data unit may comprise a socket, and the interface of the exchange station may comprise a plug which can be inserted into the socket of the combined power and data unit. For all embodiments described in this specification, any suitable form of interface can be used, and it is not required that one part should be to be inserted into another. For the avoidance of doubt, the terms “inserted into” in this specification should be interpreted to apply to any kind of interface, not limited to the interface being a plug-and-socket style interface where one part is inserted into another.

The interface may be configured to electrically couple to the power source of a combined power and data unit when connected to the interface in order to charge the rechargeable power source.

In some cases the exchange station is configured to recharge the combined power and data unit at the exchange station at the same time as updating the computer readable code. An advantage of this arrangement is convenience, since the combined power and unit remains at the exchange station until it is fully recharged and ready to be connected to the interface of another load handling device. A further advantage of the exchange station also being a charge station is that the combined power and data unit does not have to be transported to another location for charging, resulting in a simpler system with fewer stations and no need for a transport means between the exchange station and a separate charging station. A combined exchange and charging station also has the advantage of a reduction in fire risk, since the rechargeable power sources in the combined power and data units are always connected to an interface so can be monitored to ensure that the conditions (e.g. temperature) remain stable, and any fire prevention measures can be concentrated in one location.

In other cases the combined power and data units can be exchanged at the exchange station and then transported to a separate charging station to be recharged. An advantage of charging at a separate charging station is that the throughput of load handling devices at the exchange station is much faster; a combined power and data unit only needs to remain at the exchange station occupying an interface for a short time in order to receive updated computer readable code, rather than occupying an interface for the time needed to recharge.

The exchange station may comprise a socket arrangement comprising one or more sockets arranged to hold and store a corresponding number of combined power and data units, the one or more sockets configured to electrically couple to the rechargeable power source and to interface with the data storage module.

Exchange stations are located on or adjacent to the track structure for connecting/disconnecting combined power and data units to/from load handling devices operating on the track structure.

The actuator may be able to reach or extend to a load handling device which is located on the track structure, adjacent to the exchange station, and access a combined power and data unit. Also, the actuator may be able to reach or extend to a socket arrangement for holding and storing combined power and data units.

When not in use the actuator may be positioned to provide clearance between the exchange station and load handling devices operating on the track system.

The actuator may comprise a robot arm. The robotic arm may have an end of arm tool, otherwise known as an end effector, which may be a gripper designed to securely grip a combined power and data unit. Any suitable end effector can be used, that is able to hold and move a combined power and data unit.

If the combined power and data unit has a mechanical release mechanism, the actuator may be able to release the mechanical release mechanism of the combined power and data unit in order to remove the combined power and data unit from a load handling device or from a socket.

The end effector may have a special finger with a key to operate a mechanical release mechanism to allow the combined power and data unit to be removed from the container handling device and the socket of the exchange station.

The actuator may comprise gripper fingers having pressure or contact sensors. Pressure or contact sensors may be used to ensure a good grasp before the combined power and data unit is removed from a load handling device or a socket.

Combined power and data units may be recharged when held in a socket via the electrical coupling, to replenish the power source.

The interface may further comprise a charge providing connector configured to connect to a corresponding connector on a combined power and storage unit when connected to the interface, the charge providing connector being configured to:
electrically couple to and provide power to the rechargeable power source; and
interface with and transfer computer readable code to the data storage module.

Similar to the charge receiving connector on the load handling device described above, the charge providing connector is able to fulfil two functions simultaneously, i.e. the same connector can both provide charge and transfer data. Data can be transferred in both directions; for example computer readable code can be transferred from the exchange station to the combined power and data unit, and diagnostic data can be transferred from the combined power and data unit to the exchange station.

A high speed data link may be required, for example USB 2.0 which can provide a transfer speed of 480 Mbit/second. The data storage module may comprise one or more USB flash memory sticks, which are widely and cheaply available, and designed for hot-swap connection. The charge providing connector may comprise a power connector, ground connector, and a differential pair of data connectors, and the corresponding connector on the combined power and data unit may comprise a corresponding power connector, ground connector, and corresponding differential pair of data connectors. The charge providing connector and/or the corresponding connector on the combined power and data unit may comprise a shield to protect the connectors from electromagnetic interference.

The corresponding connector on the combined power and storage unit may be configured to interface with both the charge providing connector in the interface of the exchange station and a charge receiving connector on a load handling device.

The interface may be configured to receive diagnostic data from the data storage module of a combined power and data unit when connected to the interface.

Data from the data storage module (for example, from the local storage component of the data storage module) may be transferred or downloaded when the combined power and data unit is connected to the interface (for example, held in a socket), and/or computer readable code may be uploaded to the data storage module.

The interface with the data storage module may be arranged to receive data or transfer data from/to the data storage module.

In cases where sensors on the load handling device collect diagnostic data, the diagnostic data may be transferred to the system controller at an exchange station when the combined power and data unit is removed from the load handling device and placed in a socket at the exchange station for recharging the power source and transferring data.

The interface with the data storage module may be a high bandwidth data connection, for example an optical fibre connection or ethernet connection or a USB 2.0 connection as described above. Alternatively, the transfer means may be a LiFi arrangement. Data may be transferred by any suitable means.

Transfer of power and or data at the exchange station may be wireless.

The exchange station may further comprise a communication module configured to receive data signals from and/or transmit data signals to a system controller and/or a local processing unit on the load handling device.

Once the local data is downloaded at the interface, the exchange station may transmit the data to the system controller. In this way diagnostic logs and other data collected by a load handling device may be transferred from the load handling device to the system controller.

Since the number of exchange stations may be proportionate to the number of load handling devices, the number of connections or interfaces for download may be proportionate to the number of load handling devices. The system may provide sufficient data bandwidth such that detailed technical diagnostics may be created, downloaded at an exchange station, and stored centrally and analysed by the system controller, for all load handling devices operating in the system and recorded for all time the system is in operation.

Meanwhile, one or more versions of computer readable code may be uploaded to the data storage module ready for when the combined power and data unit is redeployed.

It will be appreciated that simultaneously to data transfer, the rechargeable power source of the combined power and data unit is recharged. Transmitting and receiving data to/from the data storage module may occur at the same time as recharging the rechargeable power source.

The data signals received from the system controller and/or the local processing unit comprise instructions to replace a combined power and data unit in the load handling device. An instruction to replace a combined power and data unit can be issued either from the system controller, or from an individual load handling device (for example, in response to the charge level in the rechargeable power source falling below a predetermined charge threshold and the load handling device needing to exchange the depleted rechargeable power source for a recharged power source).

The local processing unit may monitor the rechargeable power source of an inserted combined power and data unit. When the rechargeable power source is low on power, typically low enough to warrant having the rechargeable power source changed, leaving a margin of safety to avoid leaving load handling devices stranded due to low power, the local processing unit may direct the load handling device to an exchange station to have the combined power and data unit replaced.

Further, the local processing unit may monitor the local data storage component of the data storage module. When the local data storage component is approaching capacity, the local processing unit may direct the load handling device to an exchange station to have the combined power and data unit replaced.

Alternatively, the local processing unit may receive instructions from the system controller via the communication module. In some circumstances the system controller may direct the load handling device to an exchange station due to a need to update the computer readable code on the load handling device.

Thus, the load handling device may be directed to an exchange station by its own local processing unit or by the system controller.

The socket arrangement may comprise: a rack, or a container stored below the grid.

The socket arrangement may take any form that is within reach of the actuator arm. For example, the socket arrangement may be a shelf arrangement with compartments or sockets for receiving combined power and data units. In another example, the socket arrangement may comprise a series of compartments on a rotating carousel or loop, akin to a Paternoster lift arrangement. In this way, when required either an empty compartment may be presented to the actuator arm ready to receive a combined power and data unit, or a compartment with a combined power and data unit having a recharged power source and updated data storage module may be presented, ready to be connected to a load handling device.

Where the socket arrangement is located in a container stored below the grid, the container may be for example, a fire resistant tote or container. The fire resistant tote or container may be of a type that may be lifted and moved by a load handling device operating on the grid. In this way, a replenished socket arrangement container may be brought to a location adjacent to the exchange station.

An exchange station may further comprise sensors to detect a parked load handling device. The exchange station may further comprise a control unit. In this way, the control unit may command the robotic arm to remove a combined power and data unit from the load handling device when the load handling device arrives at the exchange station. The sensors may comprise a vision system.

Further the sensor system may be able to detect that the load handling device has been powered down, for example from the absence of lights on the control panel of the load handling device. In this way, the exchange station may wait until it is safe to remove the combined power and data unit from the load handling device.

Each socket may comprise a light unit for locating a combined power and data unit.

The light unit may be similar to that of the load handling device receptacle, and operate in a similar way. The light unit may displaying signals that are visible to the actuator. The light units may guide removal/insertion of combined power and data units into sockets. The one or more light units may display pre-arranged coded signals, for example, using colour and or amplitude modulation. A specific light signal may identify a specific socket. In this way, an actuator may be guided to the correct socket and or deployment ready combined power and data unit.

It will be appreciated that charging at exchange stations and rechargeable power sources such as rechargeable batteries may represent a potential fire risk.

Accordingly, an exchange station may further comprise fire heat sensors, smoke sensors and or fire detection.

These may be fitted together with the sensors for detecting load handling devices, or these may be fitted to each socket. The sensors may provide data to the exchange station controller, or to the system controller.

An exchange station may further comprising fire suppression devices.

Again, these may be fitted together with the sensors for detecting load handling devices, or these may be fitted to each socket. Suppression devices may comprise means for deploying fire suppressant foam for example.

The exchange station may be clad in fire resistant material or is substantially surrounded with a fire bulkhead.

The exchange station may be temperature controlled or wherein the exchange station is temperature conditioned.

Again, these may be fitted together with the sensors for detecting load handling devices, or these may be fitted to each socket. Temperature control may be used as a means to minimise potential fire risks. Further, temperatures control may be used to facilitate optimal charging conditions for the power source.

The communication module may receive instructions from the system controller to replace a combined power and data unit in a load handling device, or wherein the communication module receives instructions from a load handling device to replace a combined power and data unit in the load handling device.

In this way, the exchange station may operate under control of the system controller, or together the exchange system and a load handling device may operate semi-autonomously without direct control from the system controller.

The actuator may be guided to remove/insert a combined power and data unit by one or more of: (a) one or more cameras providing a two dimensional image; (b) two or more cameras providing a three dimensional image; (c) a laser, an extremely high frequency (EHF) radar device or ultrasonic depth finding device to provide or supplement a three dimensional image; (d) a light detection or ranging devices and techniques that are used to create or supplement three dimensional images; (e) laser imaging, detection, and or ranging devices and techniques to create or supplement three dimensional images; (f) 3-D laser scanning devices and or techniques to create or supplement three dimensional images; and or (g) extremely high frequency (EHF) radar or ultrasonic scanning and 3-D scanning devices and techniques to create or supplement three dimensional images.

The exchange station may have a number of systems to aid operation of the actuator. The cameras or other sensors may comprise specific lighting or other means to generate guidance and or control of the actuator and gripper.

A load handling device may be directed to move to and park at an exchange station grid cell.

The exchange station grid cell may be specifically allocated for the exchange of combined power and data units.

It will be appreciated that where a load handling device has more than one slot for combined power and data units, the exchange station may replace just one of the combined power and data units, or the exchange station may replace more than one combined power and data units. The combined power and data units with diminished power/full data storage may be placed in any vacant socket at the exchange station to be recharged, and or have data logs downloaded and erased, and or have computer readable code written to the data storage module.

When selecting a second combined power and data unit to insert into a load handling device, it may be decided that the exchange station may not make a recently charged combined power and data unit available until a parameterised time period after charging to allow a monitoring period of the thermal state of the electrical energy storage, for safety reasons.

Thus, when a load handling device visits an exchange station one or more combined power and data units are exchanged for combined power and data units with a recharged power source and a data storage device cleared of log files. Whilst the power source is recharged in the exchange station, the data stored in the data storage module is downloaded over a high bandwidth network connection.

The load handling device may power down when it arrives at the exchange station grid cell.

Thus, the load handling device may be powered down before a combined power and data unit is exchanged.

The load handling device may automatically power up when the second combined power and data unit is detected.

Power up may occur after detecting a continuous power source in the slot with a voltage in a specified range, for a specified time, without interruption. In this way, the load handling device may be ready to return to lifting operations and manoeuvres on the grid quickly.

The actuator may be instructed to remove and replace a specific combined power and data unit.

The actuator may be guided to a specific socket or receptacle by one or more light units.

The robotic arm may be guided to the correct vacant slot in the exchange station by one or more light units capable of displaying pre-arranged coded signals using colour and amplitude modulation, for example.

In this way, the amount of time spent at an exchange station by each load handling device may be typically significantly less than 1% of its total operating time, thereby reducing the necessary number of power-stations, reducing the total number of load handling devices required to operate on the grid for a given throughput of the system and in turn further reducing the number of necessary power-stations.

Further, from time to time the data files used by each of the load handling devices' real-time software may be updated.

### System

A storage and retrieval system is provided, comprising:
a first set of parallel tracks extending in an X-direction, and a second set of parallel tracks extending in a Y-direction transverse to the first set in a substantially horizontal plane to form a grid pattern comprising a plurality of grid spaces;
a plurality of stacks of storage containers located beneath the tracks, and arranged such that each stack is located within a footprint of a single grid space;
one or more load handling devices as defined herein;
a system controller comprising a system data storage medium storing computer readable code to control the operation of the load handling device on the tracks; and
an exchange station as defined herein, the exchange station further comprising a communication module configured to receive data signals from and/or transmit data signals to the system controller, the exchange station being located on or adjacent to the tracks and configured for connecting/disconnecting a combined power and data unit to/from the interface of the one or more load handling devices;
   wherein the computer readable code stored on the system data storage medium is transmitted by the system controller to the exchange station via the communication module.

The load handling devices may be semi-autonomous, and as discussed above, typically operate on the grid structure powered by a rechargeable power source.

Exchange stations may be located on the grid, and or at the edge or periphery of the grid. Or exchange stations may be located on the grid structure itself. In this way the exchange stations are accessible by the load handling devices operating on the grid, and a first exchangeable or combined power and data unit may be removed from a load handling device, and replaced with a similar second combined power and data unit. The number of exchange stations arranged on a grid system may be determined by the number of load handling devices operating on the grid, and/or the typical run time before the rechargeable power source is depleted.

The system controller may direct or control the load handling devices operating on the grid. The system controller may comprise one or more system control units. The system controller may control the load handling devices via communication means.

When the power source in a particular load handling device is depleted, the load handling device may be directed to an exchange station to replace the power source.

At the exchange station, removed combined power and data units may be recharged and the diagnostic logs may be downloaded. Once the diagnostic logs have been downloaded, the diagnostic logs may be erased from the data storage module, so that the combined power and data unit is ready for deployment as a replacement combined power and data unit.

At the exchange station, the combined power and data unit may be further prepared for redeployment by uploading computer readable code. The uploaded computer readable code may comprise one or more new versions of computer readable code already present on the data storage module.

As noted above, updates may be installed according to computer readable code comprising deployment instructions. Some operation files may update the firmware of the load handling device substantially when a combined power and data unit is inserted into the receptacle of the load handling device, and the deployment of some firmware updates may be delayed until a communication is received from the system controller.

The one or more load handling devices may comprise a plurality of load handling devices, wherein the local processing unit of each of the plurality of load handling devices is configured to execute instructions stored in the data storage module in response to a communication signal from the system controller.

In some instances a “breaking change” must be deployed such that all load handling devices are updated together; which requires all load handling devices to have a copy of the new version of the operational file.

Previously, the system would have been brought to a halt for the load handling devices to be upgraded concurrently.

The computer readable code may comprise instructions for deploying an update to a load handling device in which the combined power and data unit is inserted, the update being instructed to be deployed substantially when the combined power and data unit is inserted, or the update being instructed to be deployed when a communication signal from the system controller is received.

The system controller may provide a communication signal to a plurality of load handling devices to deploy an update according to stored computer readable code across a cohort of load handling devices.

Thus, computer readable code may contain information instructing the load handling device to spontaneously update to a particular new version of the software and data files when the computer readable code is first read; or the computer readable code may contain information instructing the container handling device to wait to be commanded over the wireless communications before updating to a particular new version of the software and data files. Accordingly, software changes may be deployed individually or all together concurrently to prevent “breaking changes”.

Additionally, this makes “breaking changes” available faster compared to conventional over the wire updates as all load handling devices in the system can receive a copy of the upgrade after a single visit to an exchange station.

In this way, load handling devices may be individually updated as and when the combined power and data units are replaced, or a cohort of load handling devices may be updated together once each load handling device in the cohort has received an updated version of the computer readable code via a combined power and data unit as required by the system controller. A cohort of load handling devices may comprise the entire fleet of load handling devices operating on the track structure, or the entire fleet of load handling devices within the storage and retrieval system.

For example, in cases where a section of the track structure is to be closed for maintenance, the grid-map data file may need to be updated simultaneously for all load handling devices on the track system. Upon visiting an exchange station, each load handling device will be provided with an updated grid-map data file, and an operational file containing an instruction to wait for a signal from the system controller before switching to using the updated grid-map data file. Once all load handling devices have received the updated grid-map data file and the operational file containing the instruction to wait for a signal before updating, a signal from the system controller can be transmitted to all load handling devices simultaneously instructing all of the load handling devices to start using the newer version of the grid-map data file. In this way all of the load handling devices will know to avoid the section of the track system which is closed for maintenance, without needing to halt the operation of the load handling devices. A computer program is provided comprising instructions which, when the program is executed by a computer, cause the computer to carry out the method.

### BRIEF DESCRIPTION OF THE DRAWINGS

These and other aspects of the invention will now be described, by way of example only, and with reference to the accompanying drawings, in which:

FIG. 1 is a schematic perspective view of a grid storage structure and containers;

FIG. 2 is a schematic plan view of a track on top of the storage structure of FIG. 1;

FIG. 3 shows load handling devices on top of the storage structure of FIG. 1;

FIG. 4 is a schematic perspective view of a single load handling device with a lifting mechanism in a lowered configuration;

FIGS. 5a and 5b show a schematic cutaway views of the load handling device of FIG. 4 with the lifting mechanism in a raised (FIG. 5a) and a lowered configuration (FIG. 5b);

FIGS. 6a and 6b show schematic drawings of an open frame or skeleton modular structure for a load handling device;

FIG. 7 shows a schematic drawing of a load handling device having slots for receiving a combined battery and data unit;

FIG. 8 shows a schematic perspective drawing of an exchange station adjacent to the grid;

FIG. 9 shows a plan view of the exchange station of FIG. 8;

FIG. 10 shows a socket arrangement for an exchange station;

FIG. 11 shows a schematic view of a load handling device with a combined power and data unit inserted;

FIG. 12 shows a schematic view of a load handling device with a combined power and data unit inserted, where the load handling device has a data storage medium;

FIG. 13 shows a schematic view of a load handling device with a charge receiving connector connected to a corresponding connector in a combined power and data unit inserted;

FIG. 14 shows a schematic view of a combined power and data module inserted into a socket at an exchange station;

FIG. 15 shows a schematic view of a combined power and data module connected to a charge providing connector in a socket at an exchange station;

FIG. 16 shows a schematic view of a storage and retrieval system with a storage structure, a load handling device, and an exchange station; and

FIG. 17 is a flowchart schematically illustrating a method of updating computer readable code in a load handling device.

In the figures, like features are denoted by like reference signs where appropriate.

### DETAILED DESCRIPTION

The following embodiments represent preferred examples of how the invention may be practiced, but they are not necessarily the only examples of how this could be achieved. These examples are described in sufficient detail to enable those skilled in the art to practice the invention. Other examples may be utilised and structural changes may be made without departing from the scope of the invention as defined in the appended claims. Moreover, direction references and any other terms having an implied orientation are given by way of example to aid the reader's understanding of the particular examples described herein. They should not be read to be requirements or limitations, particularly as to the position, orientation, or use of the invention unless specifically set forth in the appended claims. Similarly, connection references (e.g., attached, coupled, connected, joined, secured, and the like) are to be construed broadly and may include intermediate members between a connection of elements and relative movement between elements. As such, connection references do not necessarily infer that two elements are directly connected and in fixed relation to each other, unless specifically set forth in the appended claims. Similarly, wording such as “movement in the n-direction” and any comparable wording, where n is one of x, y or z, is intended to mean movement substantially along or parallel to the n-axis, in either direction (i.e., towards the positive end of the n-axis or towards the negative end of the n-axis).

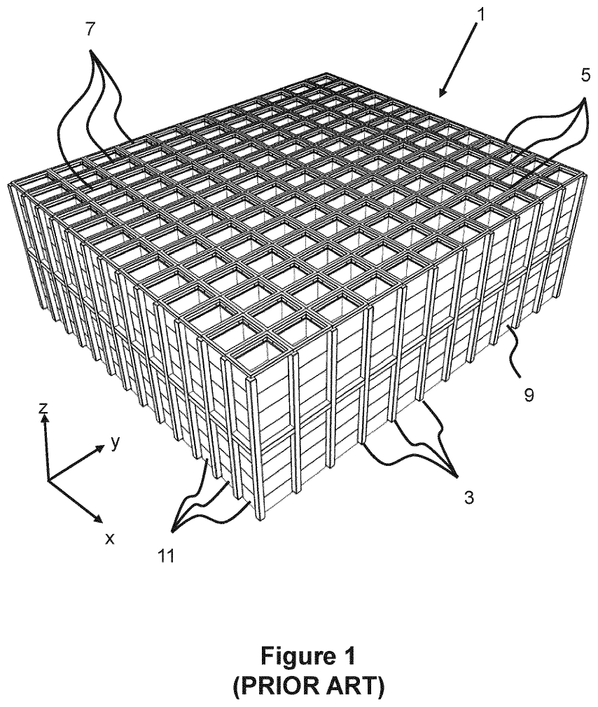

As noted above, FIG. 1 illustrates a storage structure 1 of a storage and retrieval system.

The storage structure 1 comprises a framework comprising upright members 3 and horizontal members 5, 7 which are supported by the upright members 3. The horizontal members 5 extend parallel to one another and the illustrated x-axis. The horizontal members 7 extend parallel to one another and the illustrated y-axis, and transversely to the horizontal members 5. The upright members 3 extend parallel to one another and the illustrated z-axis, and transversely to the horizontal members 5, 7. The horizontal members 5, 7 form a grid pattern defining a plurality of grid cells 14. In the illustrated example, storage containers 9 are arranged in stacks 11 beneath the grid cells 14 defined by the grid pattern, one stack 11 of containers 9 per grid cell 14.

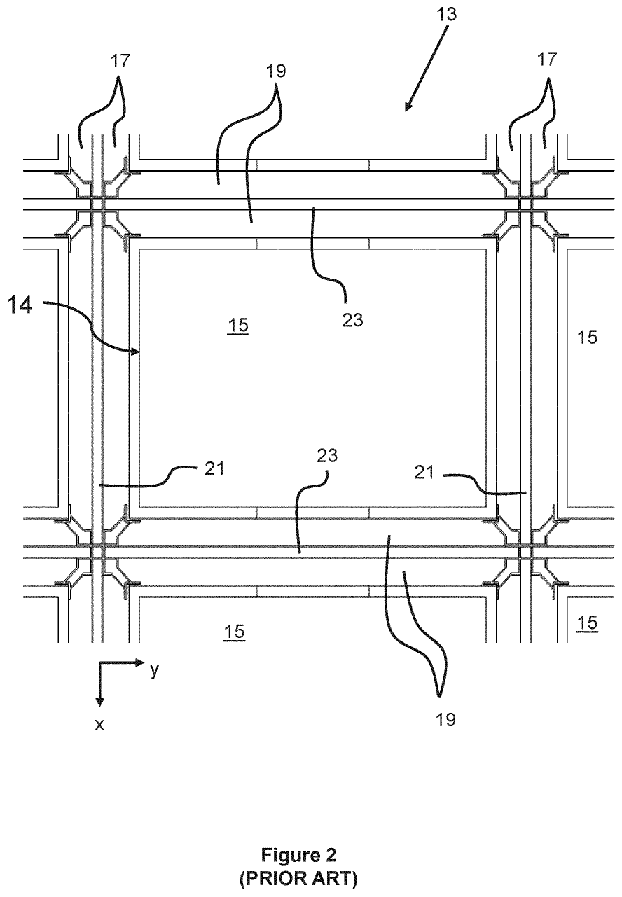

As an alternative to the upright members 3 supporting the horizontal members 5,7 as described with reference to FIG. 1, in other examples the horizontal members can be supported by support framework structure comprising a plurality of prefabricated modular panels arranged in a grid pattern, the detail of which is described in the PCT application WO2022034195A1. The storage structure described in WO2022034195A1 addresses the problem of time and cost to assemble by providing a supporting framework structure comprising a plurality of prefabricated modular panels arranged in a three dimensional grid pattern to define a plurality of grid cells. Each of the grid cells of the supporting framework structure is sized to support two or more grid cells of the track structure. The storage structure is formed from fewer structural components yet still maintains the same structural integrity as the typical “stick-built” storage structure 1 described above, and is much faster and cheaper to build. Any appropriate supporting framework structure can be used in the current invention. FIG. 2 shows a large-scale plan view of a section of track structure 13 forming part of the storage structure 1 illustrated in FIG. 1 and located on top of the horizontal members 5, 7 of the storage structure 1 illustrated in FIG. 1. The track structure 13 may be provided by the horizontal members 5, 7 themselves (e.g. formed in or on the surfaces of the horizontal members 5, 7) or by one or more additional components mounted on top of the horizontal members 5, 7. The illustrated track structure 13 comprises x-direction tracks 17 and y-direction tracks 19, i.e. a first set of tracks 17 which extend in the x-direction and a second set of tracks 19 which extend in the y-direction, transverse to the tracks 17 in the first set of tracks 17. The tracks 17, 19 define apertures 15 at the centres of the grid cells 14. The apertures 15 are sized to allow containers 9 located beneath the grid cells 14 to be lifted and lowered through the apertures 15. The x-direction tracks 17 are provided in pairs separated by channels 21, and the y-direction tracks 19 are provided in pairs separated by channels 23. Other arrangements of track structure may also be possible.

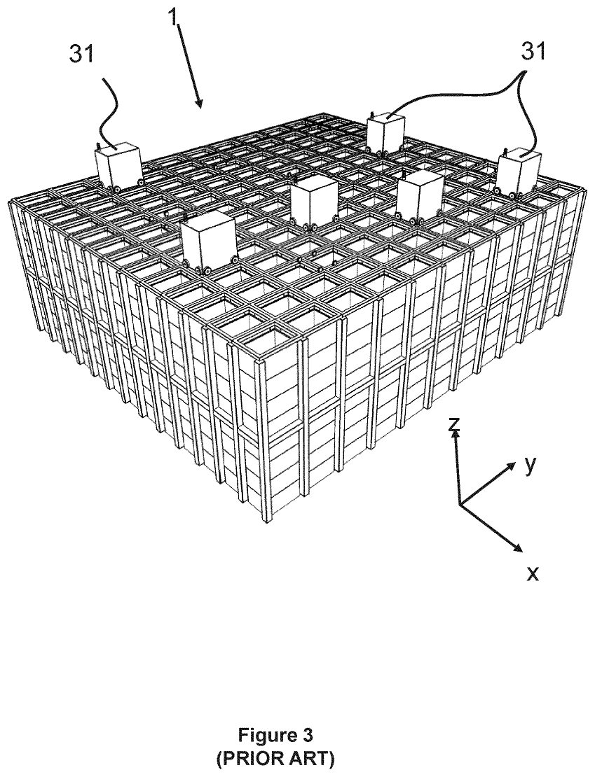

FIG. 3 shows a plurality of load handling devices 31 moving on top of the storage structure 1 illustrated in FIG. 1. The load handling devices 31, which may also be referred to as robots or bots, are provided with sets of wheels to engage with corresponding x- or y-direction tracks 17, 19 to enable the bots 31 to travel across the track structure 13 and reach specific grid cells 14. The illustrated pairs of tracks 17, 19 separated by channels 21, 23 allow bots 31 to occupy (or pass one another on) neighbouring grid cells 14 without colliding with one another.

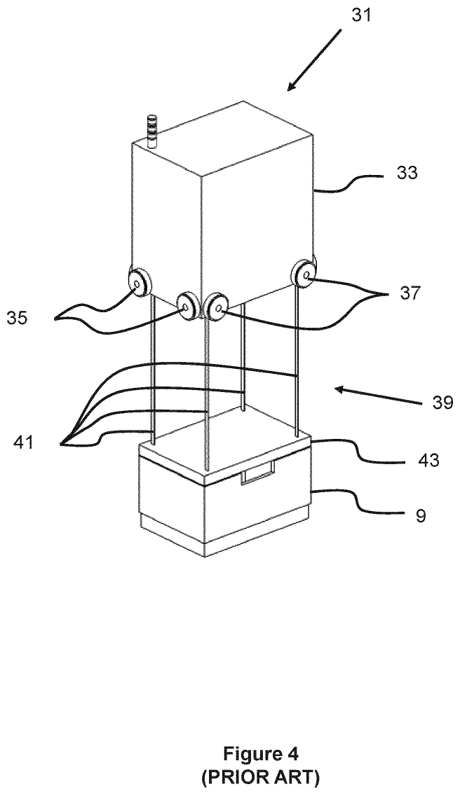

As illustrated in FIG. 4, a bot 31 comprises a body 33 in or on which are mounted one or more components which enable the bot 31 to perform its intended functions. These functions may include moving across the storage structure 1 on the track structure 13 and raising or lowering containers 9 (e.g. from or to stacks 11) so that the bot 31 can retrieve or deposit containers 9 in specific locations defined by the grid pattern.

The illustrated bot 31 comprises a driving assembly comprising first and second sets of wheels 35, 37 which are mounted on the body 33 of the bot 31 and enable the bot 31 to move in the x- and y-directions along the tracks 17 and 19, respectively. In particular, two wheels 35 are provided on the shorter side of the bot 31 visible in FIG. 4, and a further two wheels 35 are provided on the opposite shorter side of the bot 31. The wheels 35 engage with tracks 17 and are rotatably mounted on the body 33 of the bot 31 to allow the bot 31 to move along the tracks 17. Analogously, two wheels 37 are provided on the longer side of the bot 31 visible in FIG. 4, and a further two wheels 37 are provided on the opposite longer side of the bot 31. The wheels 37 engage with tracks 19 and are rotatably mounted on the body 33 of the bot 31 to allow the bot 31 to move along the tracks 19.

The bot 31 also comprises a lifting mechanism 39 configured to raise and lower containers 9. The illustrated lifting mechanism 39 comprises four tethers 41 which are connected at their lower ends to a gripping device 43. The tethers 41 may be in the form of cables, ropes, tapes, or any other form of tether with the necessary physical properties to lift the containers 9. The gripping device 43 comprises a gripping mechanism configured to engage with features of the containers 9. For example, the containers 9 may be provided with one or more apertures in their upper sides with which the gripping mechanism can engage. Alternatively or additionally, the gripping mechanism may be configured to hook under the rims or lips of the containers 9, and/or to clamp or grasp the containers 9. The tethers 41 may be wound up or down to raise or lower the gripping device 43, as required. One or more motors or other means may be provided to effect or control the winding up or down of the tethers 41.

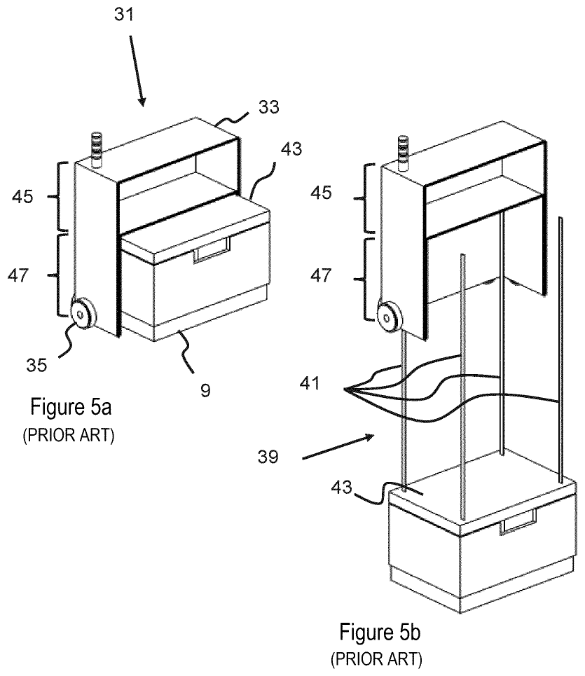

As can be seen in FIG. 5, the body 33 of the illustrated bot 31 has an upper portion 45 and a lower portion 47. The upper portion 45 is configured to house one or more operation components (not shown), such as components (e.g. motors) of the lifting mechanism, wireless communication components, etc. The lower portion 47 is arranged beneath the upper portion 45. The lower portion 47 comprises a container-receiving space or cavity for accommodating at least part of a container 9 that has been raised by the lifting mechanism 43. The container-receiving space is sized such that enough of a container 9 can fit inside the cavity to enable the bot 31 to move across the track structure 13 on top of storage structure 1 without the underside of the container 9 catching on the track structure 13 or another part of the storage structure 1. When the bot 31 has reached its intended destination, the lifting mechanism 43 controls the tethers 41 to lower the gripping device 43 and the corresponding container 9 out of the cavity and into the intended position. The intended position may be a stack 11 of containers 9 or an egress point of the storage structure 1 (or an ingress point of the storage structure 1 if the bot 31 has moved to collect a container 9 for storage in the storage structure 1). Although in the illustrated example the upper and lower portions 45, 47 are separated by a physical divider, in other examples, the upper and lower portions 45, 47 may not be physically divided by a specific component or part of the body 33 of the bot 31.

The container-receiving space of the bot 31 may not be within the body 33 of the bot 31. For example, the container-receiving space may instead be adjacent to the body 33 of the bot 31, e.g. in a cantilever arrangement with the weight of the body 33 of the bot 31 counterbalancing the weight of the container to be lifted. In such embodiments, a frame or arms of the lifting mechanism 43 may protrude horizontally from the body 33 of the bot 31, and the tethers 41 may be arranged at respective locations on the protruding frame/arms and configured to be raised and lowered from those locations to raise and lower a container into the container-receiving space adjacent to the body 33. The height at which the frame/arms is/are mounted on and protrude(s) from the body 33 of the bot 31 may be chosen to provide a desired effect.

For example, it may be preferable for the frame/arms to protrude at a high level on the body 33 of the bot 31 to allow a larger container (or a plurality of containers) to be raised into the container-receiving space beneath the frame/arms. Alternatively, the frame/arms may be arranged to protrude lower down the body 33 (but still high enough to accommodate at least one container between the frame/arms and the track structure 13) to keep the centre of mass of the bot 31 lower when the bot 31 is loaded with a container.

To enable the bot 31 to move on the different wheels 35, 37 in the first and second directions, the driving assembly further comprises a wheel-positioning mechanism for selectively engaging either the first set of wheels 35 with the first set of tracks 17 or the second set of wheels 37 with the second set of tracks 19. The wheel-positioning mechanism is configured to raise and lower the first set of wheels 35 and/or the second set of wheels 37 relative to the body 33, thereby enabling the load handling device 31 to selectively move in either the first direction or the second direction across the tracks 17, 19 of the storage structure 1.

The wheel-positioning mechanism may include one or more linear actuators, rotary components or other means for raising and lowering at least one set of wheels 35, 37 relative to the body 33 of the bot 31 to bring the at least one set of wheels 35, 37 out of and into contact with the tracks 17, 19. In some examples, only one set of wheels is configured to be raised and lowered, and the act of lowering the one set of wheels may effectively lift the other set of wheels clear of the corresponding tracks while the act of raising the one set of wheels may effectively lower the other set of wheels into contact with the corresponding tracks. In other examples, both sets of wheels may be raised and lowered, advantageously meaning that the body 33 of the bot 31 stays substantially at the same height and therefore the weight of the body 33 and the components mounted thereon does not need to be lifted and lowered by the wheel-positioning mechanism.

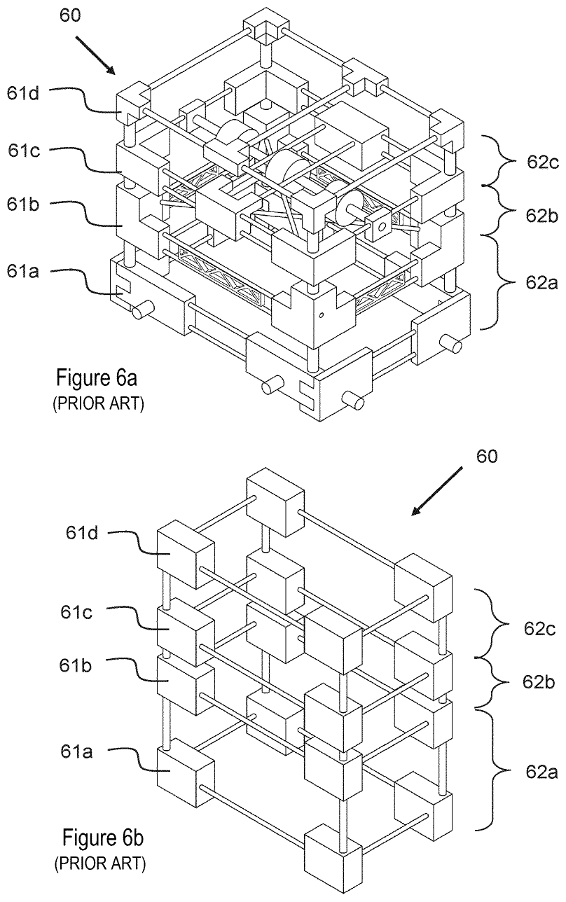

FIGS. 6a and 6b illustrate an open frame or skeleton modular structure 60 for an alternative load handling device. FIG. 6a shows a skeleton structure for a load handling, while FIG. 6b shows a simplified model version of the structure, having block construction forming a vertically stacked layered structure.

Four modular sections 61a, 61b, 61c, 61d are shown in the stack. Each of the four modular sections, a first 61a, second 61b, third 61c and fourth modular section 61d, may provide one or more of the functional characteristics of the load handling device. For the purposes of discussion herein, the first modular section 61a is at the bottom of the load handling device 60 and the fourth modular section 61d is at the top of the load handling device 60.

Layers 62a, 62b, 62c may be defined as the space between each of the modular sections 61a, 61b, 61c, 61d. Each of the layers 62 may carry at least a portion of one or more of the functional components of the load handling device 60. It will be appreciated that the number and position or layers 62a, 62b, 62c is not limited to the layers defined by the four modular sections 61a, 61b, 61c, 61d shown in FIGS. 6 (a) and (b), and may include any number of modular sections 61 to provide additional layers and volume for functional characteristics of the load handling device 60. It will be appreciated that functional characteristics may be shared a number of layers.

A modular section 61a, 61b, 61c, 61d is built by connecting adjacent connecting blocks in the same horizontal plane by one or more connecting elements to form an open rectangular frame. Blocks may be fixedly connected, or blocks may be moveably connected. Each layer is an open rectangular frame formed by connecting or linking together corner brackets, where each corner bracket is shown as a connecting block in FIG. 6b. Vertically adjacent modular sections are connected together by connecting vertically adjacent connecting blocks to form the open frame or skeleton structure 60. The corner brackets in a single modular section 61a, 61b, 61c, 61d may be indirectly connected to other brackets intermediate of the corner brackets by additional connecting elements, for example illustrated in FIG. 6a for module sections 61c and 61d. Thus, the term “connected” may mean directly and/or indirectly.

The connecting elements may be connecting rods or tubes for linking adjacent connecting blocks together. The connecting rods may be solid or hollow.

The open frame structure 60 is a three dimensional structure defining a volume having an upper portion i.e. layer 62c typically for housing a power source, control unit, spools carrying the lifting tethers etc., and a lower portion i.e. layer 62a for housing a lifted the container.

The structural integrity of the open frame structure 60 should be sufficient to not only support the different functional characteristics of the load handling device but also have sufficient flexural rigidity when the load handling device is operational on the grid structure. Various materials can be used in the fabrication of the connecting rods or tubes. These include but are not limited to metal or polymers or ceramic or a combination thereof. To reduce the weight of the load handling device and have the necessary structural properties to support the different functional components of the load handling device, optionally the connecting rods linking adjacent corner brackets together are composed of carbon fibre bound in a polymer matrix (known as carbon fibre or CF rods). To aid with the construction of the rectangular frames forming the modular sections 61a, 62b, 62c, each of the connecting blocks of one or more of the modular sections comprises an opening or socket for insertion of the connecting rods. The connecting rod is fixed to the connecting block by a joint. Various joints can be used to fix the connecting rods to the corner brackets in a modular section. These include various fasteners, glues, welding etc.

The same corner brackets for connecting to two other corner brackets in a single modular section can be used to vertically connect adjacent rectangular frames together to form layers 62a, 62b, 62c. The corner brackets of vertically adjacent rectangular frames can be mounted to the same vertical connecting element at each corner of the open frame structure 60 such that the vertical connecting element extends though the corner brackets of multiple vertically adjacent rectangular frames. As a result, each of the corners of the open frame structure 60 may share the same or common vertical connecting element. It will be appreciated that storage and retrieval systems of the type described above may be operated with a fleet of load handling devices. The fleet may be homogenous, or the fleet may be of varying type of load handling device. The load handling devices described in connection with FIGS. 4-6 are some examples of types of load handling device.

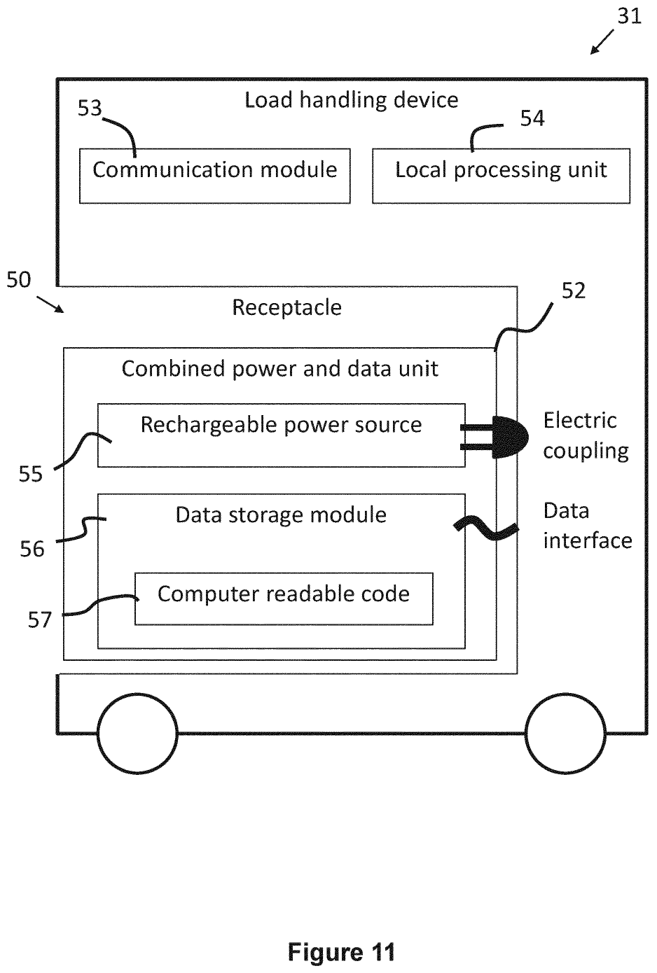

FIG. 11 shows a schematic view of a load handling device 31 with a combined power and data unit 52 inserted. The load handling device 52 comprises a receptacle 50 for receiving the combined power and data unit 52. The receptacle 50 is externally accessible to facilitate insertion and retrieval of the combined power and data unit 52. As described above, the combined power and data unit 52 comprises a rechargeable power source 55 (for example a rechargeable battery) and a data storage module 56 comprising data associated with computer readable code 58.

The load handling device 31 comprises a communication module 53 for receiving data from and/or transmitting data to a system controller. The communication module 53 can transmit information about the current status of the load handling device 31 to the system controller (for example, current position and any error data). The communication module 53 can receive data and instructions from the system controller, for example an instruction to navigate to a specific grid cell 14 or to retrieve a specific container 9. Data can be transmitted and/or received by the communication module wirelessly.

The load handling device 31 comprises a local processing unit 54. The local processing unit 54 controls the operation of the load handling device 31, and is in communication with the communication module 53. For example, the local processing unit 54 can control the driving assembly, the wheels, the direction change mechanism, the lifting mechanism, and/or other components of the load handling device.

The receptacle 50 of the load handling device comprises means for electrically coupling to the combined power and data unit 52 received within the receptacle 50. The electrical coupling may be achieved by one or more physical connectors (for example, contact pads or cables), or by wireless transfer means (for example, inductive charging).

The receptacle 50 comprises a data interface for transferring data to and/or receiving data from the data storage module 56 of the combined power and data unit 52 received within the receptacle 50. The data transfer may be achieved by one or more physical connectors (for example, USB cables or other data cables), or by wireless transfer means.

The combined power and data unit 52 comprises a rechargeable power source 55, for example a rechargeable battery, and a data storage module 56. The data storage module 56 comprises computer readable code 57 for controlling the operation of the load handling device 31. The local processing unit 54 is configured to access the computer readable code 57, for example to control the operation of the load handling device 31 on the track structure 13. The interface between the load handling device 31 and the combined power and data unit 52 in the illustrated example is a receptacle 50, but in other examples, other forms of interface can be used. In other examples, the interface between the combined power and data unit and the load handling device can take any suitable form, not necessarily requiring the combined power and data unit to be inserted into a receptacle or slot in the load handling device. Although this specific example shows the load handling device 31 with a single receptacle 50 for a single combined power and data unit 52, in other examples the load handling device may be provided with more than one receptacle 50.

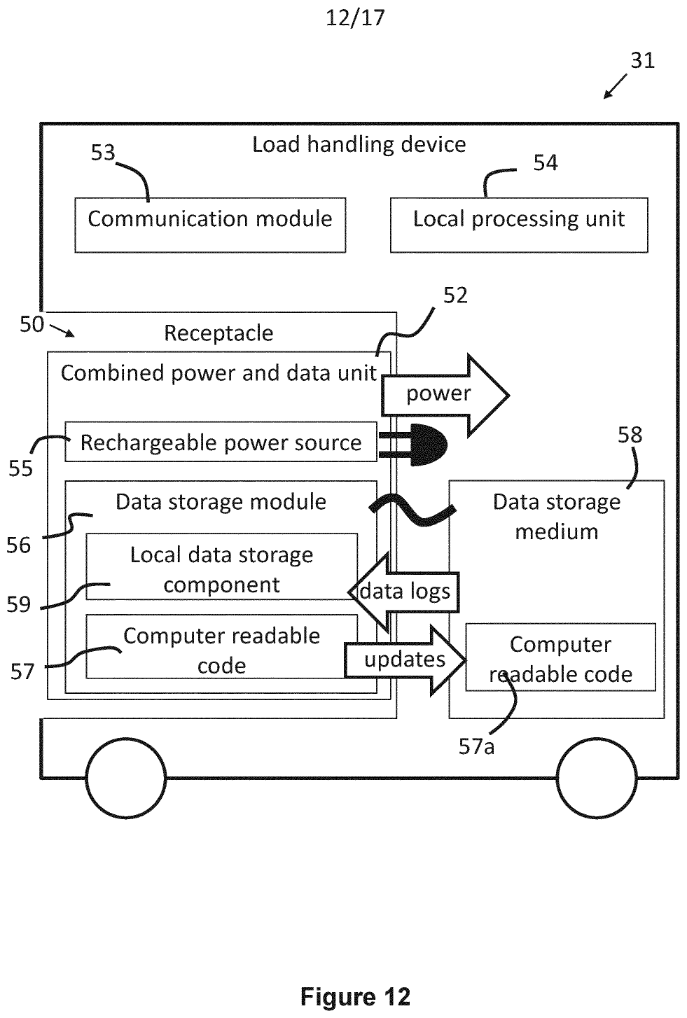

FIG. 12 shows a schematic view of a load handling device 31 with a combined power and data unit 52 inserted, where the load handling device 31 comprises a data storage medium 58. The data interface is configured to transfer data between the data storage medium 58 of the load handling device 31 and the data storage module 56 of a combined power and data unit 52 inserted into the receptacle 50 of the load handling device 31.

The data storage medium 58 comprises computer readable code 57a. When a combined power and data unit 52 is received within the receptacle 50 of the load handling device, the computer readable code 57 in the data storage module can be used to update the computer readable code 57a on the data storage medium of the load handling device. For example, the process of updating computer readable code can comprise copying new computer readable code 57 to the data storage medium 58, or updated versions 57 of existing computer readable code 57a.

In this example the data storage module 56 comprises a local data storage component 59 for storing data logs in the data storage module 56 of the combined power and data unit 52. Data logs, for example data collected by sensors (not shown) on the load handling device 31, can be transmitted from the data storage medium 58 to the local data storage component 59. In this way, when the combined power and data unit 52 is swapped for another combined power and data unit at an exchange station, the data logs are removed from the load handling device 31. The data logs can be downloaded at an exchange station and removed from the local data storage component 59.

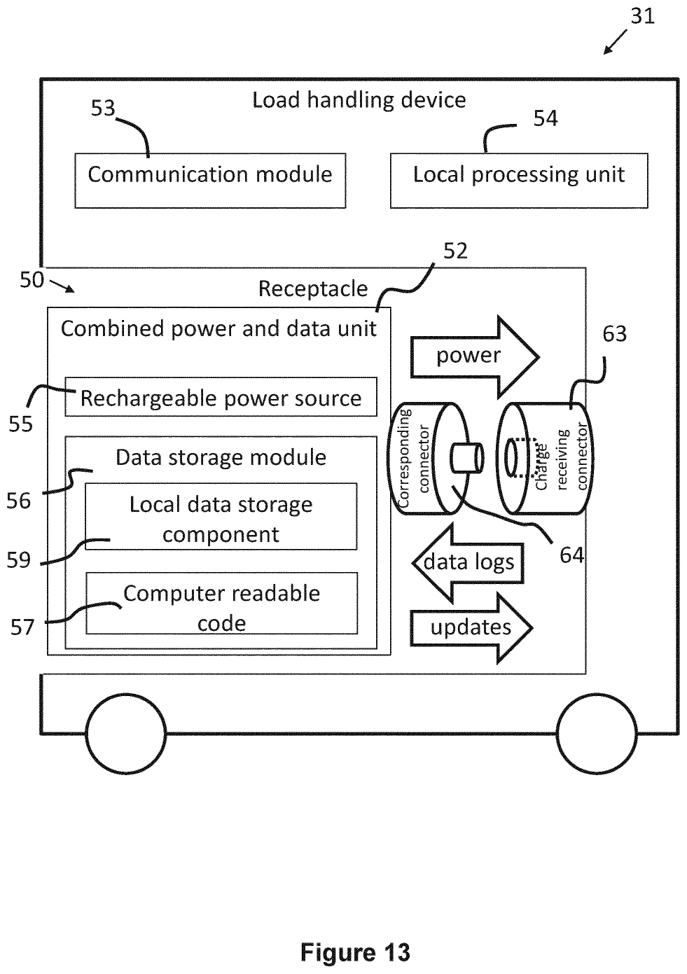

FIG. 13 shows a schematic view of a load handling device 31 with a charge receiving connector connected 63 to a corresponding connector 64 in a combined power and data unit 52. The charge receiving connector 63 receives power from the corresponding connector 64 of the combined power and data unit 52, and the power is provided to the driving assembly of the load handling device 31, and possibly also to other components of the load handling device 31. The charge receiving connector 63 can also receive data from and/or transmit data to the corresponding connector 64 of the combined power and data unit 52. Data logs can be transferred from the load handling device 31 to the data storage module 56, and/or in the other direction updates to computer readable code can be transferred from the data storage module 56 to the load handling device 31. The charge receiving connector 63 and the corresponding connector 64 engage with each other to provide both the electrical coupling between the rechargeable power source 55 in the combined power and data module 55 and the load handling device 31, and the data interface between the data storage module 56 and the load handling device 31.

The charge receiving connector may comprise a power connector, ground connector, and a differential pair of data connectors, and the corresponding connector on the combined power and data unit may comprise a corresponding power connector, ground connector, and corresponding differential pair of data connectors. The charge receiving connector and/or the corresponding connector on the combined power and data unit may comprise a shield to protect the connectors from electromagnetic interference. Any suitable data connector may be used, for example a USB connector.

The charge receiving connector 63 may be configured to engage with the corresponding connector 64 upon insertion of the combined power and data unit 52 into the receptacle 50 of the load handling device 31.

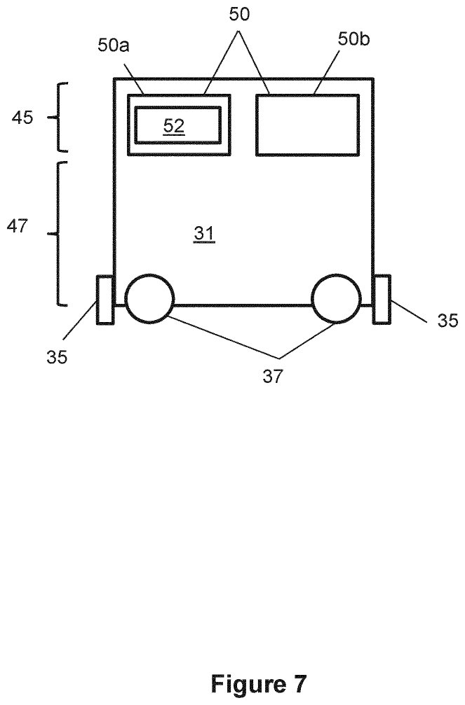

FIG. 7 shows a schematic drawing of a load handling device 31 having receptacles or slots 50 for receiving a combined power and data unit 52. The load handling device 31 may be of the type illustrated in FIGS. 1-5 having a ‘body’ for housing functional components, or of the type illustrated in FIG. 6 having merely a skeleton frame for attaching functional components. The load handling device 31 has a lower portion 47 for receiving a lifted container, and an upper portion 45 for housing functional systems. The load handling device 31 is supported by a first set of wheels 35 and a second set of wheels 37, for moving on the track structure of a storage cube. The load handling device 31 may also house a lifting mechanism, local control unit and communication module and other functional components or systems.

The functional systems housed in the upper portion 45 of the load handling device 31 comprising one or more receptacle slot(s) 50 for receiving a combined power and data unit 52.

As shown in FIG. 7, the upper portion 45 comprises two receptacles or slots 50, a first slot 50a, and a second slot 50b. The slot 50a is tenanted by a combined power and data unit 52, while slot 50b is vacant. It will be appreciated that both slots 50a and 50b may be occupied with respective combined power and data units 52. In this way, as shown, the load handling device 31 may carry two combined power and data units 52. Each receptacle is arranged to electrically couple to the power source of an inserted combined power and data unit 52, and also each receptacle is arranged to interface with the data storage module of an inserted combined power and data unit 52.

The combined power and data unit 52 is configured to provide sufficient power to operate the driving assembly, wheels 35, 37, lifting mechanism and communication module and other functional systems of the load handling device 31.

The data interface is arranged to read and update firmware of the load handling device from the data storage module of an inserted combined power and data unit 52. Firmware updates may comprise operational files stored on the storage module of an inserted combined power and data unit 52. Further, when operating on the grid, operational and sensor data may be collected and stored on or written to an inserted combined power and data unit 52 via the data interface.

The operational data files may comprise one or more of: (a) a grid-map data file, (b) load handling device control software, (c) load handling device motor drive controlling software, or (d) load handling device communication software.

Load handling device motor drive controlling software can be firmware or software to control the drive assembly of the load handling device, e.g. to drive the wheels of the load handling device in order to enable the load handling device to move on the track structure. The drive assembly may comprise one or more electric motors, which are controlled by the load handling device motor drive controlling software. Operational files may control the speed, torque, power, or direction of the one or more motors. The operational files may include instructions for trajectory generation, i.e. software configured to generate a trajectory of speed and acceleration vs. time to define the motion of the load handling device in moving to another grid cell on the track system, and instructions for translating the linear speed/acceleration requirements of the load handling device to speed/torque/power required from the one or more motors.

Load handling device communication software can control the transmitting and receiving of data from the load handling device to a system controller.

Load handling device control software can be firmware or software to control other parts of the load handling device. For example, operational files can be provided to control the direction of travel of the load handling device by activating a directional change mechanism and/or a wheel-positioning mechanism. The operational files may control the wheel-positioning mechanism to selectively engage the first set of wheels 35 with the first set of tracks 17 by lowering the first set of wheels 35 relative to the body 33 so that the first set of wheels 35 engages with the first set of tracks 17 and the load handling device 31 can move in the first direction across the track system. In other examples of load handling device control firmware, operational files can be firmware to control the load handling device 31 to lift a container from a stack or lower a container onto a stack, for example by controlling the speed of the ascent or descent of the container while being lifted or lowered, and by controlling the gripping mechanism on the gripping device to engage with or release a container. Operational files can be firmware to control the position of the load handling relative to the track system based on the one or more position sensors configured for sensing one or more markers on the track system.

Although the slots 50 are illustrated as being located in the upper portion 45 of the load handling device 31 and arranged substantially horizontally, the compartments or slots 50 may be located at any externally accessible position within, on or attached to the load handling device 31. The slots 50 of the may optionally comprise a locking mechanism for releasably locking a combined power and data unit 52 in the holder 50.

When the power source of an inserted combined power and data unit 52 is low on power, or the data store of an inserted combined power and data unit 52 is approaching capacity, the load handling device 31 may be instructed to move to an exchange station 70 grid cell. The instruction may be from a local control unit, local to the load handling device 31 itself, or the instruction may be from a central control unit, central to the storage and retrieval system.

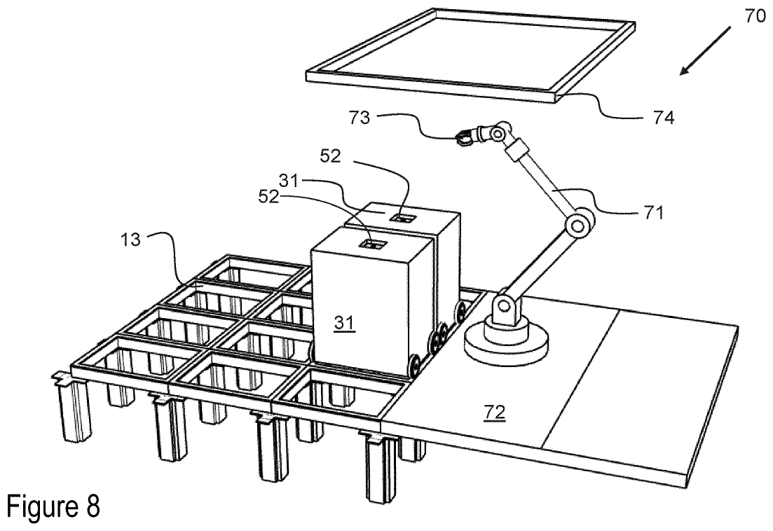

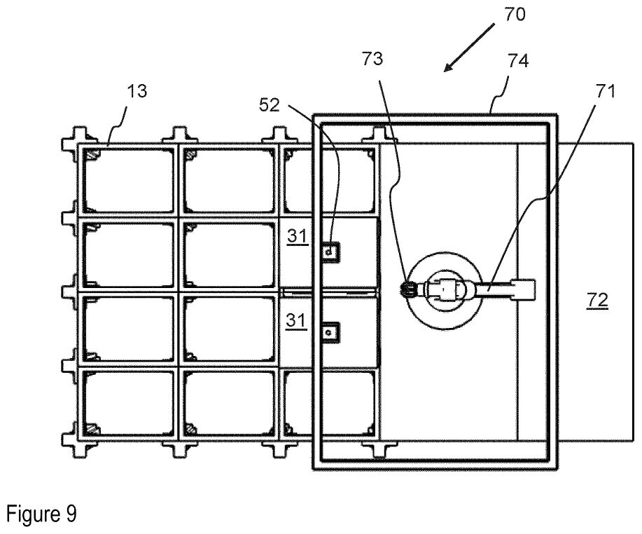

FIGS. 8 and 9 show an example exchange station 70 in the form of a robotic arm 71 located on a platform 72 adjacent to the outer perimeter of a portion of the track structure 13. The robotic arm 71 comprises a base at one end and an actuator 73 at the other end. The base is fixed with respect to the track structure 13 by mounting it on the platform 72. The illustrated actuator 73 is in the form of a gripper for physically grasping the combined power and data unit 52; however, the actuator 73 may take any form suitable for releasably holding the combined power and data unit 52. The actuator 73 comprises a pair of gripping members selectively moveable between a gripping position for holding the combined power and data unit 52 and a release position for releasing the combined power and data unit 52. The base and the actuator 73 are connected by a series of linkages and joints. The joints are configured to give the robotic arm 71 the desired degrees of freedom to allow it to remove a combined power and data unit 52 from the slot 50 and place it in a designated area, and/or to pick up a replacement combined power and data unit 52 from the designated area and insert it into a slot 50. In this illustrated example, the robotic arm 71 is a 6-axis robotic arm (i.e. the joints provide six degrees of freedom), which allows for relatively complex movements that provides flexibility with regard to the relative positioning between the load handling device 31, the robotic arm 71 and the designated area. In the example illustrated in FIG. 8, the slots 50 are arranged substantially vertically having access from the top of the load handling device 31.

The robotic arm 71 is configured to exchange the combined power and data unit 52 of a load handling device 31 that is located on a designated grid cell 14 adjacent to the robotic arm 71. The load handling device 31 remains on the designated grid cell 14a during exchange of combined power and data units 52, which includes the period for removing the low power and or at capacity combined power and data unit 52, the period for inserting a replacement combined power and data unit 52, and the period in between.

Depending on the size and configuration of the robotic arm 71, the robotic arm 71 may be configured to interact with a load handling device 31 on any one of a plurality of designated grid cells 14 in the vicinity of the robotic arm 71. In other words, the actuator 73 of the robotic arm 71 may be movable to the receptacles 50 of two or more stationary load handling devices 31 that are in the vicinity of the robotic arm 71, as shown in FIG. 8. This allows the robotic arm 71 to continue performing exchanges of combined power and data units 52 even if a load handling device 31 malfunctions and blocks one of the designated grid cells 14.

In some embodiments, located above the robotic arm 71, and extending at least partially over the designated grid cells 14, a sensor halo 74 may be provided. The sensor halo 74 has a vision system and is able to detect when a load handling device 31 is parked on a designated grid cell 14. Further, the sensor halo 74 is able to detect when a load handling device 31 has powered down, ensuring that it is safe to remove a combined power and data unit 52. Once powered down, the vision system may locate the combined power and data unit 52 and be used to direct the actuator 73 to grab the combined power and data unit 52, and move it to a designated area. To replace a combined power and data unit 52, the vision system may locate an empty receptacle 50 and used to direct an actuator 73 carrying a replacement combined power and data unit 52 to insert the combined power and data unit 52 into the unoccupied receptacle 50.

The sensor halo 74 can also house sensors and devices for controlling the environment around the exchange station 70, for example, temperature control and for detecting and suppressing fires.

It will be appreciated that instead of being located on a platform adjacent to the outer perimeter of the track structure 13, the robotic arm 71 may also be located on the track structure 13 itself, e.g. on a grid cell 14 of the track structure 13.

Instead of a single robotic arm 71 performing both removal and insertion operations, a first robotic arm 71 can be provided to remove a combined power and data unit 52 from the receptacle 50 and a second robotic arm 71 can be provided to insert a replacement combined power and data unit 52 into the receptacle 50. Such an arrangement can result in quicker and more efficient power source exchanges because a replacement combined power and data unit 52 can be inserted into the receptacle 50 immediately after the low power/full combined power and data unit 52 has been removed as there is no need to wait for the first robotic arm 71 to place low power/full combined power and data unit 52 in a designated area and pick up a replacement combined power and data unit 52. The first robotic arm 71 and the second robotic arm 71 may be configured to perform their respective removal and insertion operations while the load handling device 31 remains on the same grid cell 14a.

The robotic arm 71 is not limited to having a base 72 fixed with respect to the track structure 13. Instead, the base 72 may be configured to move relative to the track structure 13. For example, the base 72 may comprise wheels or other driving means. This allows the robotic arm 71 to perform power source exchanges (removal and/or insertion) over a plurality of different grid cells 14 (e.g. a row of grid cells 14). The base 72 may be configured to move adjacent to the outer perimeter of the track structure 13, or the base 72 may be configured to move on the tracks of the track structure 13 itself (e.g. in the X and/or Y direction).

The robotic arm 71 is not limited to being a 6-axis robotic arm. At a minimum, the robotic arm 71 comprises an actuator 73 that is movable relative to a load handling device 31 to allow the robotic arm 71 to remove and insert a combined power and data unit 52. To provide more complex movements, the robotic arm 71 may comprise further degrees of freedom, e.g. the robotic arm 71 may be a 2, 3, 4, or 5-axis robotic arm. The robotic arm 71 may also comprise more than six degrees of freedom, e.g. a 7-axis robotic arm. In other arrangements, the robotic arm may be replaced with an actuator operating on a Cartesian bar and cable system.

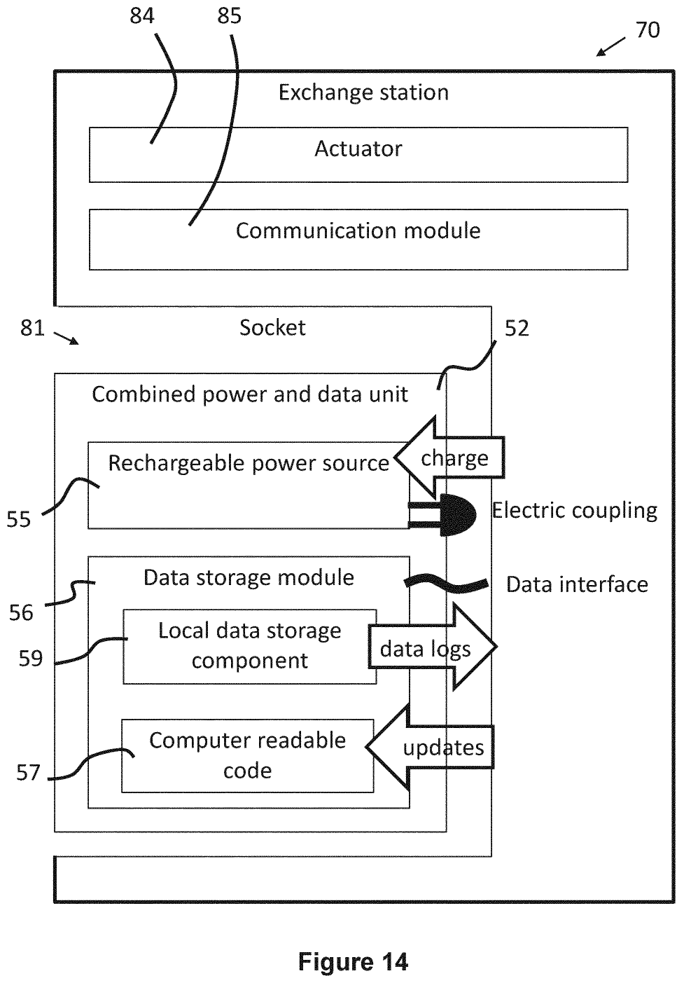

FIG. 14 shows a schematic view of a combined power and data module 52 inserted into a socket 81 at an exchange station 70. In the illustrated example the interface between the exchange station and the combined power and data unit takes the form of a socket into which a combined power and data unit may be inserted, but in other examples other forms of interface can be used. In the illustrated example only one socket 81 is provided, but in other examples the exchange station may be provided with multiple sockets 81. The socket 81 is externally accessible, so that a combined power and data unit 52 can easily be inserted or removed. In the illustrated example the socket 81 is externally accessible from the side of the exchange station 70, so the combined power and data unit 52 can be inserted or extracted in a horizontal direction, but in other examples one or more sockets 81 may be accessible from different directions.

The exchange station is provided with an actuator 84 (for example a robotic arm), which is able to remove a combined power and data unit 52 from a receptacle 50 of a load handling device 31 and place the combined power and data unit 52 into a socket 81 of the exchange station. Conversely, the actuator 84 can remove a combined power and data unit 52 from a socket 81 of the exchange station and place the combined power and data unit 52 into a receptacle 50 of a load handling device 31. Thus, when a load handling device 31 approaches the exchange station 70, the actuator 84 can remove the combined power and data unit 52 currently inserted in the load handling device 31, and replace with a fresh combined power and data unit 52. In this way the load handling device 31 can be provided with a fully charged combined power and data unit 52 and continue operating on the track system 13. As will be described in more detail below, the actuator can be a robot arm with an end effector configured to grip and hold the combined power and data unit 52.

The exchange station also comprises a communication module 85, which is able to receive data signals from and/or transmit data signals to a system controller and/or a local processing unit on a load handling device.

When a combined power and data unit 52 is inserted into the socket 81, the socket 81 electrically couples to the combined power and data unit 52 so that power can be transferred in order to charge the rechargeable power source 55 in the combined power and data unit 52. The socket 81 is also configured to establish a data channel with the combined power and data unit 52 so that data can be transferred between the data storage module 56 and the socket 81. Data can be transferred in both directions: data logs from the data storage module 56 (in this example, data logs stored in the local data storage component 59) can be transferred from the data storage module to the socket. Conversely, updated operational files (for example, new operational files or updated versions of existing operational files) can be transferred from the socket to the data storage module 56.

In the illustrated example, the combined power and data unit 52 is recharged at the exchange station at the same time as data is transferred, so the combined power and unit remains at the exchange station until it is fully recharged and ready to be inserted into another load handling device. In other examples, these two functions may be separated, i.e. the data may be transferred at the exchange station 70 and then the combined power and data unit 52 may be transferred to another charging station to be recharged.

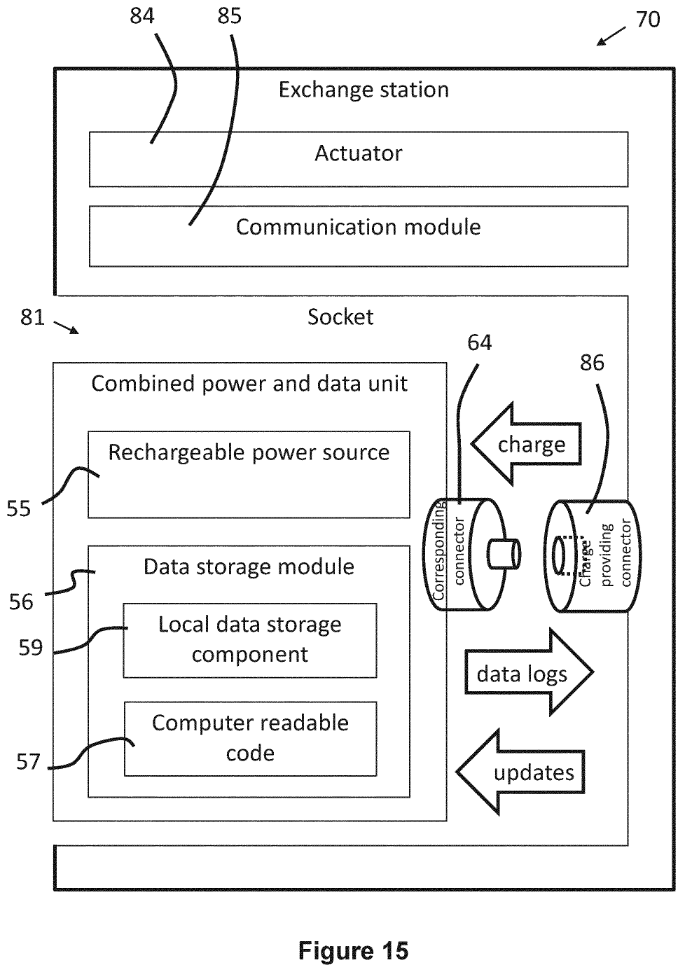

FIG. 15 shows a schematic view of a combined power and data module 52 connected to a charge providing connector 86 in a socket 81 at an exchange station 70. The combined power and data unit 52 comprises a corresponding connector 64 configured to engage with the charge providing connector 86 of the socket 81. The corresponding connector 64 on the combined power and storage unit 52 is the same corresponding connector 64 as illustrated in FIG. 13. In other words, the corresponding connector 64 is able to interface with both the charge providing connector 63 in the socket 81 of the exchange station 70, and a charge receiving connector 63 on a load handling device 31.

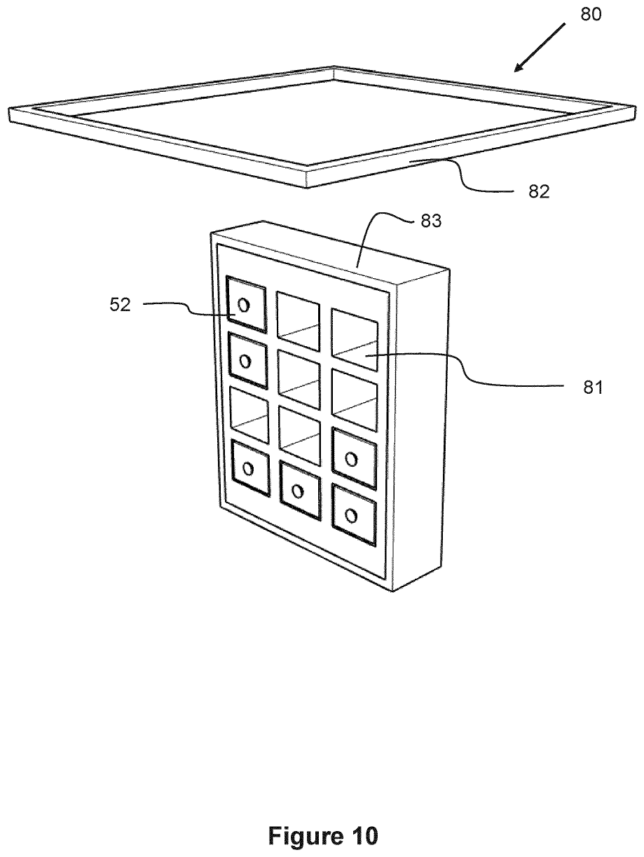

When a combined power and data unit 52 is received within the socket 81, the charge providing connector 86 in the socket 81 of the exchange station 70 provides both electrical coupling between the socket and the rechargeable power source 55 in the combined power and data unit, and a data interface between the data storage module 56 and the socket 81. Similar to the charge receiving connector on the load handling device described above, the charge providing connector is able to fulfil two functions simultaneously, i.e. the same connector can both provide charge and transfer data. Data can be transferred in both directions; for example computer readable code 57 or updates to computer readable code can be transferred from the exchange station 70 to the combined power and data unit 52, and diagnostic data or data logs can be transferred from the combined power and data unit 52 to the exchange station 70. FIG. 10 shows a socket arrangement 80 for storing combined power and data units 52 in the above-described system. The socket arrangement 80 comprises a plurality of holders 81, each configured to receive a combined power and data units 52. In this illustrated example, the holders 81 are in the form of individual compartments within a structure, but the holders 81 can take any suitable form for receiving combined power and data units 52, e.g. a shelf, a rack, a container etc.

The socket arrangement 80 may be located on the platform 72 adjacent to the outer perimeter of the track structure 13, e.g. in the designated area, such that the socket arrangement 80 is are accessible by robotic arm 71 operating in the exchange station 70. The exchanging apparatus 70 is configured to remove a low power/full combined power and data unit 31 from a load handling device 31 and place it into one of the vacant holders 81. The exchanging apparatus 70 is further configured to retrieve a replacement combined power and data unit 52 from an occupied holder 81 and place it into the vacant power source compartment 50 of the load handling device. The socket arrangement 80 may, for example, be used with a 6-axis robotic arm, such as the robotic arm 71 illustrated in FIGS. 8 and 9.

The holders 81 comprise charging means for charging the combined power and data units 52 when received in the holders. For example, the power source holders may comprise electrical connectors (not shown) configured to couple to the electrical connectors of the combined power and data units 52. Further, the holders 81 comprise a data interface to download diagnostic logs from the storage component. Diagnostic logs are then transmitted to the system controller and the diagnostic logs are erased from the combined power and data unit. Similarly, updated operational files are uploaded to the combined power and data units 52 for deployment to a load handling device 31 when the refreshed combined power and data units 52 are inserted into the load handling device 31. Transfer of power and or data within the load handling device may be wireless.

The socket arrangement 80 is optionally accessible from a rear side to allow a combined power and data unit 52 to be inserted into or removed from the socket arrangement 80 from the rear side. The rear side is defined as a side of the storage station facing away from the track structure 13. The rear side of the socket arrangement 80 may face a maintenance area accessible by human workers. This arrangement allows a combined power and data unit 52 to be removed from the power source storage station by a human worker (e.g. for maintenance) without the worker having to be located in an area with potentially dangerous equipment (e.g. the track structure 13, the load handling device 31, the exchange station 70, etc.), or without having to shut down the potentially dangerous equipment.

The location of the socket arrangements described above are not limited to being adjacent to the outer perimeter of the track structure 13. The socket arrangements may be located at any other suitable location accessible by the actuator of a robotic arm, e.g. on the track structure 13 itself.

The holders 81 of the socket arrangement 80 may optionally comprise a locking mechanism for releasably locking a combined power and data unit 52 in a holder 81, similar to the locking mechanisms for releasably locking the combined power and data unit 52 in the power source compartment 50.

The socket arrangement 80 may optionally comprise fire resistant cladding 83 surrounding the holders 81.

The socket arrangement 80 may optionally comprise a sensor and device halo 82, similar to the halo 74 for the exchange station 70 described above.

The socket arrangement 80 may also comprise a power source monitoring system to monitor the charge state of the power sources within the holders 81. The control system may use this information to determine which occupied holder from which the exchanging apparatus 70 should retrieve a replacement combined power and data unit.

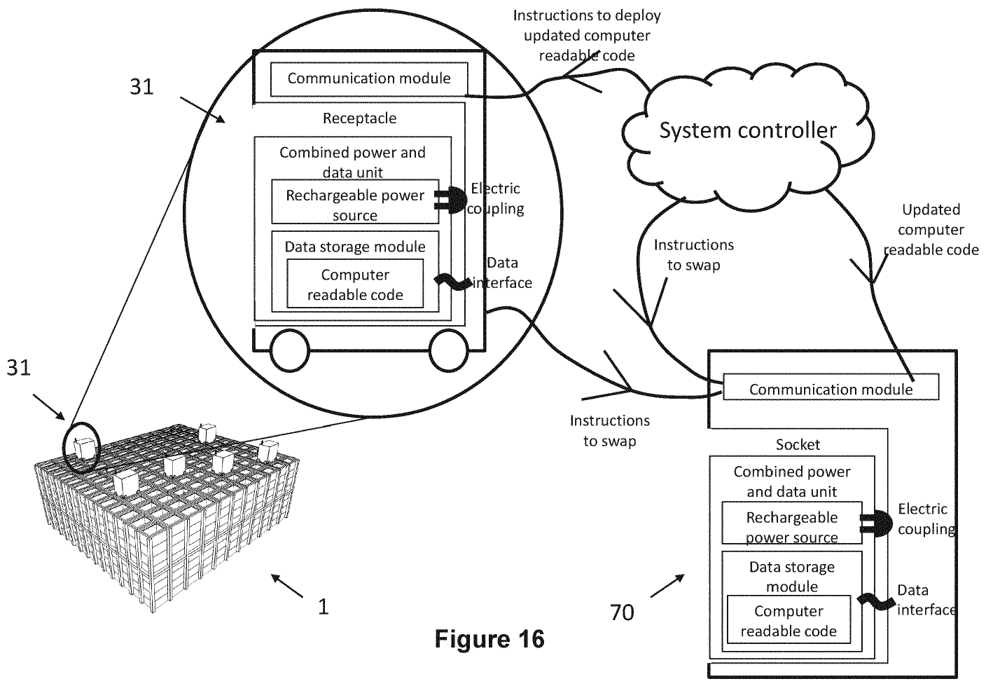

FIG. 16 shows a schematic view of a storage and retrieval system with a storage structure 1, a load handling device 31, and an exchange station 70. The figure illustrates some examples of communications between the different aspects of the system.

Updated computer readable code can be provided to the exchange stations 70 by the system controller. Once an exchange station has been provided with updated computer readable code, every time a combined power and data unit 52 is swapped out at the exchange station, the exchange station can provide the updated computer readable code when the combined power and data unit is connected to the interface of the exchange station.

In some cases the computer readable code can comprise new files or new versions of existing files that are required to be deployed to all of the load handling devices on the track system at the same time, as described above, i.e. the load handling devices are instructed to wait for a signal from the system controller before starting to use the updated computer readable code. This may happen in the case of “breaking changes”. The system controller may send instructions to deploy the updated computer readable code to all load handling device simultaneously.

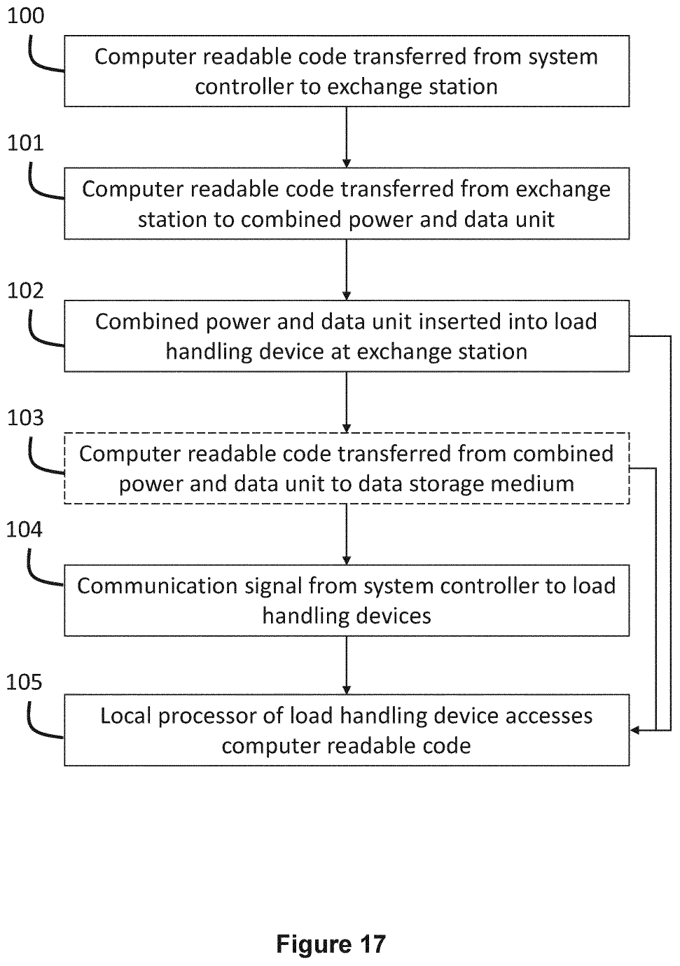

Either the system controller or an individual load handling device 31 can send a communication signal to an exchange station to exchange a combined power and data unit. The communication signal received by the exchange station from the system controller and/or a load handling device may comprise instructions to replace a combined power and data unit in the load handling device. An instruction to replace a combined power and data unit can be issued from the system controller. This could happen if, for example, the system controller determines that the particular load handling device needs an update to its computer readable code, i.e. the combined power and data unit in the load handling device does not have the latest version of the computer readable code. The instruction can be issued from an individual load handling device, for example, in response to the charge level in the rechargeable power source falling below a predetermined charge threshold and the load handling device needing to exchange the power source for a recharged power source, or by the data storage module running out of space to store further data logs from the sensors on the load handling device. FIG. 17 schematically illustrates a method of updating computer readable code in a load handling device, for example when there is a change to the computer readable code and the updated computer readable code needs to be deployed throughout a storage and retrieval system. In a step 100, computer readable code is transferred from the system controller to an exchange station. In a storage and retrieval system comprising a plurality of exchange stations, the same computer readable code can be transmitted to all of the exchange stations at the time. In a step 101, the computer readable code is transferred from the exchange station to a combined power and data unit at the exchange station. In a step 102, the combined power and data unit (now containing the updated computer readable code) is connected to the interface of a load handling device at the exchange station. Over a period of time, steps 101 and 102 will ensure that the computer readable code is uploaded onto all of the combined power and data units in the storage and retrieval system, and eventually all of the load handling devices in the storage and retrieval system will be provided with the updated computer readable code. In a step 103, the computer readable code is transferred from the combined power and data unit to a data storage medium in the load handling device. This step 103 is optional; in some examples the local processing unit of the load handling device may access the computer readable code from the combined power and data unit rather than from the data storage medium. In a step 104, a communication signal is sent from the system controller to the load handling devices in the storage and retrieval system, with instructions to deploy the updated computer readable code. In a step 105, the local processor of the load handling device accesses the computer readable code and starts to use the updated version. As described above, the method step of the system controller sending a communication signal to the load handling devices is useful to co-ordinate the simultaneous deployment of computer readable code, for example an updated data parameter or a new instruction that could be a “breaking change”. Alternatively, the local processing units of the load handling devices can access the computer readable code immediately, thus skipping from step 102 or 103 directly to step 105, as indicated by the arrows on the right of the flowchart.

The above description of embodiments of the invention has been presented for the purpose of illustration and description. It is not intended to be exhaustive or to limit the invention to the precise forms disclosed. Modifications and variations can be made without departing from the scope of the invention as defined in the claims.

### Definitions

In this document, the language “movement in the n-direction” (and related wording), where n is one of x, y and z, is intended to mean movement substantially along or parallel to the n-axis, in either direction (i.e. towards the positive end of the n-axis or towards the negative end of the n-axis).

In this document, the word “connect” and its derivatives are intended to include the possibilities of direct and indirection connection. For example, “x is connected to y” is intended to include the possibility that x is directly connected to y, with no intervening components, and the possibility that x is indirectly connected to y, with one or more intervening components. Where a direct connection is intended, the words “directly connected”, “direct connection” or similar will be used. Similarly, the word “support” and its derivatives are intended to include the possibilities of direct and indirect contact. For example, “x supports y” is intended to include the possibility that x directly supports and directly contacts y, with no intervening components, and the possibility that x indirectly supports y, with one or more intervening components contacting x and/or y. The word “mount” and its derivatives are intended to include the possibility of direct and indirect mounting. For example, “x is mounted on y” is intended to include the possibility that x is directly mounted on y, with no intervening components, and the possibility that x is indirectly mounted on y, with one or more intervening components.

In this document, the word “comprise” and its derivatives are intended to have an inclusive rather than an exclusive meaning. For example, “x comprises y” is intended to include the possibilities that x includes one and only one y, multiple y's, or one or more y's and one or more other elements. Where an exclusive meaning is intended, the language “x is composed of y” will be used, meaning that x includes only y and nothing else.

In this document, “controller” is intended to include any hardware which is suitable for controlling (e.g. providing instructions to) one or more other components. For example, a processor equipped with one or more memories and appropriate software to process data relating to a component or components and send appropriate instructions to the component(s) to enable the component(s) to perform its/their intended function(s).

The invention may also be described with reference to the following numbered clauses:

1. A storage and retrieval system comprising:
a storage structure comprising a track structure, the track structure comprising a first set of tracks and a second set of tracks, the first set of tracks extending in a first direction and the second set of tracks extending in a second direction, the second direction being substantially perpendicular to the first direction to form a grid pattern defining a plurality of grid cells;
a plurality of stacks of containers arranged within the storage structure, each stack being arranged below a grid cell;
one or more load handling devices configured to move horizontally on the track structure;
one or more exchange stations located on or adjacent to the track structure for removing/inserting combined power and data units from/into the one or more load handling devices; and
   a system controller, wherein the combined power and data units each comprise:
a power source, wherein the power source is rechargeable at a said exchange station; and
a data storage module, the data storage module comprising a local data storage component and operational files, wherein one or more operational files are provided by the system controller and are stored on the data storage module at the said exchange station.

2. A storage and retrieval system according to clause 1, wherein the operational data files comprise one or more of:
(a) a grid-map data file,
(b) load handling device control software,
(c) load handling device motor drive controlling software, or
(d) load handling device communication software.

3. A storage and retrieval system according to any of clauses 1-2, wherein the one or more operational files comprise instructions for deploying an update to a load handling device in which the combined power and data unit is inserted,
the update being instructed to be deployed substantially when the a combined power and data unit is inserted, or
the update being instructed to be deployed when a communication signal from the system controller is received.

4. A storage and retrieval system according to any of clauses 1-3, wherein the system control unit provides a communication signal to a plurality of load handling devices to deploy an update according to stored operational files across a cohort of load handling devices.

5. A load handling device for lifting and moving containers in a storage and retrieval system according to any of clauses 1-4, the load handling device comprising:
a driving assembly configured to horizontally move the load handling device on the track structure;
a lifting mechanism configured to lift a container from a stack;
a communication module; and
a receptacle configured to removably receive a combined power and data unit, wherein the receptacle is externally accessible, configured to electrically couple to the power source and to interface with the data storage module.

6. A load handling device according to clause 5, further comprising means for detecting a continuous power source in the receptacle.

7. A load handling device according to any of clauses 5-6, wherein the receptacle comprises a light unit for locating a combined power and data unit.

8. A load handling device according to clause 5-7, further comprising a local control unit for operating the load handling device according to the operational data files.

9. A load handling device according to any of clauses 5-8, further comprising means for writing one or more diagnostic logs to the data storage module.

10. An exchange station for a storage and retrieval system according to any of clauses 1-4, for removing/inserting combined power and data units, the exchange-station comprising:
an actuator to releasably hold and move a combined power and data unit, the combined power and data unit comprising a power source and a data storage module;
a socket arrangement comprising one or more sockets arranged to hold and store a corresponding number of combined power and data units, the one or more sockets configured to electrically couple to the power source and to interface with the data storage module; and
a communication module configured to receive and transmit data signals with a controller.

11. An exchange station according to clause 10, wherein the interface with the data storage module is arranged to receive data or transfer data from/to the data storage module.

12. An exchange station according to any of clauses 10-11, wherein the socket arrangement comprises: a rack, or a container stored below the grid.

13. An exchange station according to any of clauses 10-12, further comprising sensors to detect a parked load handling device.

14. An exchange station according to any of clauses 10-13, wherein each socket comprises a light unit for locating a combined power and data unit.

15. An exchange station according to any of clauses 10-14, further comprising fire heat sensors, smoke sensors and or fire detection.

16. An exchange station according to any of clauses 10-15, further comprising fire suppression devices.

17. An exchange station according to any of clauses 10-16, wherein the exchange station is clad in fire resistant material or is substantially surrounded with a fire bulkhead.

18. An exchange station according to any of clauses 10-17, wherein the exchange station is temperature controlled or wherein the exchange station is temperature conditioned.

19. An exchange station according to any of clauses 10-18, wherein the communication module receives instructions from the system controller to replace a combined power and data unit in a load handling device, or wherein the communication module receives instructions from a load handling device to replace a combined power and data unit in the load handling device.

20. An exchange station according to any of clauses 10-19, wherein the actuator is guided to remove/insert a combined power and data unit by one or more of:
(a) one or more cameras providing a two dimensional image;
(b) two or more cameras providing a three dimensional image;
(c) a laser, an extremely high frequency (EHF) radar device or ultrasonic depth finding device to provide or supplement a three dimensional image;
(d) a light detection or ranging devices and techniques that are used to create or supplement three dimensional images;
(e) laser imaging, detection, and or ranging devices and techniques to create or supplement three dimensional images;
(f) 3-D laser scanning devices and or techniques to create or supplement three dimensional images; and or

(g) extremely high frequency (EHF) radar or ultrasonic scanning and 3-D scanning devices and techniques to create or supplement three dimensional images.

21. A method of exchanging data at an exchange station according to any of clauses 10-20 between one or more load handling devices according to any of clauses 5-9 operating in a storage and retrieval system according to any of clauses 1-4, wherein the method comprises the steps of:
navigating a load handling device to an exchange station grid cell;
at the exchange station grid cell the actuator receives instructions to remove a first combined power and data unit from the load handling device, and insert the first combined power and data unit into a socket; and
the actuator receives instructions to remove a second combined power and data unit from a socket, and insert the second combined power and data unit into a load handling device.

22. A method according to any of clauses 21, wherein the load handling device powers down when it arrives at the exchange station grid cell.

23. A method according to any of clauses 21-22, wherein the load handling device automatically powers up when the second combined power and data unit is detected.

24. A method according to any of clauses 21-23, wherein the actuator is instructed to remove and replace a specific combined power and data unit.

25. A method according to any of clauses 21-24, wherein the actuator is guided to a specific socket or receptacle by one or more light units.

26. A computer program comprising instructions which, when the program is executed by a computer, cause the computer to carry out the method according to any of clauses 21-25.

Alternatively, the invention may be described with reference to the following numbered clauses: A. A robotic load handling device for lifting and moving containers stacked in a storage system comprising a framework supporting a track system comprising a first set of tracks and a second set of tracks, the first set of tracks extending in a first direction and the second set of tracks extending in a second direction, the second direction being substantially perpendicular to the first direction and arranged in a grid pattern above the stacks of containers, the robotic load handling device comprising:
i) a replaceable power cartridge housing a power source;
ii) a power source compartment configured to removably receive the replaceable power cartridge, said power source compartment comprising means for electrically coupling with the power source;
iii) a lifting device comprising a lifting drive assembly and a grabber device configured, in use, to releasably grip a container and lift the container from the stack into a container-receiving space;
iv) a driving mechanism operatively arranged for moving the robotic load handling device on the grid framework; said driving mechanism is powered by the power source,
iv) a storage medium comprising at least one firmware associated with controlling the operation of the driving mechanism and/or lifting drive assembly;
v) a control system comprising one or more processors and configured to execute instructions associated with the firmware in the storage medium to control the operation of the driving mechanism and/or lifting drive assembly;
characterised in that the robotic load handling device further comprises;
an auxiliary storage medium housed within the replaceable power cartridge, said auxiliary storage medium comprising one or more updates of the firmware and wherein the control system is configured to establish a data channel with the auxiliary storage medium such that the at least one firmware associated with the operation of the driving mechanism and/or lifting drive assembly is updated from the one or more updates of the firmware stored on the auxiliary storage medium.

B. The robotic load handling device of clause A, further comprising a wheel assembly driven by the driving assembly, said wheel assembly comprising a first set of wheels for engaging with the first set of tracks to guide movement of the load handling device in a first direction and a second set of wheels for engaging with the second set of tracks to guide the movement of the load handling device in a second direction, wherein the second direction is transverse to the first direction;
wherein the at least one firmware comprises a drive firmware associated with controlling the driving mechanism of the wheel assembly.

C. The robotic load handling device of clause B, further comprising a directional change mechanism configured to selectively engage the first set of wheels with the first set of tracks and the second set of wheels with the second set of tracks;
wherein the a least one firmware comprises a directional change firmware associated with controlling the operation of the directional change mechanism.

D. The robotic load handling device of any of the preceding clauses, wherein the at least one firmware comprises a trajectory generator for generating a motion profile of the robotic load handling device on the track system.

E. The robotic load handling device of clause D, wherein the trajectory generator is based on an s-curve profile generation.

F. The robotic load handling device of any of the preceding clauses, further comprising one or more position sensors configured for sensing one or more markers on the track system;
wherein the at least one firmware comprises a position controller associated with controlling the position of the robotic load handling relative to the track system based on the one or more position sensors.

G. The robotic load handling device of any of the preceding clauses, further comprising a communication module for transmitting and receiving data over a communication network; wherein the at least one firmware comprises a communication firmware for controlling the transmittal and reception of data over the communication network.

H. The robotic load handling device of clause A, where the control system is configured to transfer at least a portion of data log acquired during operation of the driving mechanism and/or lifting drive assembly to the auxiliary storage medium.

I. The robotic load handling device of any of the preceding clauses, wherein the power source is a battery.

J. An automated storage and retrieval system comprising:
i) a first set of parallel tracks and a second set of parallel tracks, the first set of parallel tracks extending in a first direction and the second set of parallel tracks extending in a second direction, the second direction being substantially perpendicular to the first direction in a grid pattern to define a track system lying in a substantially horizontal plane and comprising a plurality of grid cells,
ii) plurality of storage columns located below the track system, each of the plurality of storage columns is located below a grid cell and arranged to store a stack of storage containers;
iii) one or more robotic load handling devices as defined in any of the clauses A to I operable on the track system.

1-32. (canceled)

33. A method of providing software to a load handling device for use in a storage and retrieval system, the storage and retrieval system including a first set of parallel tracks extending in an X-direction, and a second set of parallel tracks extending in a Y-direction transverse to the first set in a substantially horizontal plane to form a grid pattern including a plurality of grid spaces, the method comprising:
transferring computer readable code to a combined power and data unit, the combined power and data unit including a rechargeable power source and a data storage module such that the computer readable code is stored in the data storage module; and
connecting the combined power and data unit to an interface of the load handling device such that the local processing unit of the load handling device can access the computer readable code stored in the data storage module,
wherein the computer readable code includes computer executable instructions such that the local processing unit of the load handling device executes the computer executable instructions to control the operation of the load handling device.

34. A method according to claim 33, wherein the method comprises:
the load handling device transferring some or all of the computer readable code from the data storage module of the combined power and data unit to a data storage medium of the load handling device.

35. A method according to claim 34, wherein the load handling device overwrites computer readable code stored on the data storage medium of the load handling device with computer readable code transferred from the data storage module of the combined power and data unit.

36. A method according to claim 33, wherein the storage and retrieval system includes one or more exchange stations, the or each exchange station being configured to connect a combined power and data unit to the interface of a load handling device or to remove a combined power and data unit from the interface of a load handling device, the method comprising:
transmitting computer readable code to an exchange station such that the computer readable code can be transferred to the data storage module of a combined power and data unit connected to the interface at said exchange station.

37. A method according to claim 36, wherein the storage and retrieval system includes a system controller, the system controller being configured to transmit computer readable code to the or each exchange station, the method comprising:
the system controller preventing the local processing unit of the load handling device from accessing the computer readable code until a predetermined condition is met.

38. A method according to claim 37, wherein the computer readable code comprises:
one or more data parameters which are accessed by the local processing unit of the load handling device during the operation of the load handling device, and the one or more data parameters include predetermined timestamps at which associated portions of the computer readable code may be accessed by the local processing unit of the load handling device.

39. A method according to claim 38, wherein the load handling device comprises:
a communications module configured, in use, to receive communications from the system controller such that one or more portions of the computer readable code are accessed by the local processing unit of the load handling device in response to the receipt of a control message from the system controller.

40. A method according to claim 39, comprising:
the load handling device overwriting computer readable code stored on the data storage medium of the load handling device with computer readable code transferred from the data storage module of the combined power and data unit in response to the receipt of a control message from the system controller.

41. A load handling device for a storage and retrieval system, the storage and retrieval system including a first set of parallel tracks extending in an X-direction, and a second set of parallel tracks extending in a Y-direction transverse to the first set in a substantially horizontal plane to form a grid pattern including a plurality of grid spaces, and a plurality of stacks of storage containers located beneath the tracks, and arranged such that each stack is located within a footprint of a single grid space, the load handling device comprising:
a driving assembly configured to move the load handling device on one of the sets of parallel tracks;
a lifting mechanism configured to lift a storage container from a stack;
a communication module for receiving data from and/or transmitting data to a system controller;
a local processing unit in communication with the communication module; and
an interface configured to:
i) connect to a combined power and data unit, the combined power and data unit including a rechargeable power source and a data storage module;
ii) electrically couple to the rechargeable power source such that, in use, the driving assembly is powered by the rechargeable power source; and
iii) communicate with the data storage module; wherein the data storage module includes computer readable code and the local processing unit is configured, in use, to access the computer readable code,
wherein the computer readable code includes computer executable instructions and the local processing unit is configured, in use, to execute the computer executable instructions to control the operation of the load handling device.

42. A load handling device according to claim 41, wherein the load handling device comprises:
a data storage medium communicably coupled to the local processing unit, the data storage medium including computer readable code.

43. A load handling device according to claim 42, wherein the local processing unit is configured, in use, to selectively execute computer executable instructions stored on either the data storage module of the combined power and data unit or the data storage medium of the load handling device.

44. A load handling device according to claim 41, wherein the computer readable code comprises:
computer executable instructions for controlling the communication module receiving data from and/or transmitting data to a system controller.

45. A load handling device according to claim 41, wherein the computer readable code comprises:
one or more data parameters and the local processing unit is configured, in use, to access at least one of the one or more data parameters during the operation of the load handling device; and
optionally, wherein the one or more data parameters include a grid-map data file for determining one or more pathways across the tracks for the load handling device.

46. A load handling device according to claim 41, the load handling device comprising:
one or more position sensors configured for sensing one or more position markers on the tracks, wherein the computer readable code includes data acquired from the one or more position sensors such that the position of the load handling relative to the tracks will be controlled based on the acquired position sensor data.

47. A load handling device according to claim 41, the load handling device further comprising:
one or more sensors for recording diagnostic data, wherein the computer readable code includes the stored diagnostic data.

48. A load handling device according to claim 43 in combination with an exchange station for connecting/disconnecting a combined power and data unit to/from the load handling device, the exchange station comprising:
an actuator configured to releasably hold and move the combined power and data unit; and
an interface arranged to connect to a combined power and data unit, the interface being arranged to establish a data channel with the combined power and data unit to receive data from and/or transfer data to the data storage module of the combined power and data unit connected to the interface;
wherein the exchange station is configured to update computer readable code stored in the data storage module when the combined power and data unit is connected to the interface; and
wherein the computer readable code includes computer executable instructions and the local processing unit of the load handling device is configured, in use, to execute the computer executable instructions to control the operation of the load handling device.

49. The exchange station of claim 48, wherein the interface is configured to electrically couple to the rechargeable power source of a combined power and data unit when connected to the interface in order to charge the rechargeable power source.

50. The exchange station of claim 48, wherein the interface is configured to receive diagnostic data from the data storage module of a combined power and data unit when connected to the interface.

51. The exchange station of any one of claim 48, comprising:
a communication module configured to receive data signals from and/or transmit data signals to a system controller and/or a local processing unit on the load handling device; and
optionally, wherein the data signals received from the system controller and/or the local processing unit include instructions to replace a combined power and data unit in the load handling device.

52. A load handling device according to claim 43, in combination with a storage and retrieval system comprising:
a first set of parallel tracks extending in an X-direction, and a second set of parallel tracks extending in a Y-direction transverse to the first set in a substantially horizontal plane to form a grid pattern including a plurality of grid spaces;
a plurality of stacks of storage containers located beneath the tracks, and arranged such that each stack is located within a footprint of a single grid space;
one or more of the load handling devices as defined;
a system controller comprising a system data storage medium computer readable code to control the operation of the load handling device on the tracks; and
an exchange station including a communication module configured to receive data signals from and/or transmit data signals to the system controller, the exchange station being located on or adjacent to the tracks and configured for connecting/disconnecting a combined power and data unit to/from the one or more load handling devices; wherein the computer readable code stored on the system data storage medium is transmitted by the system controller to the exchange station via the communication module.
